(19) United States
(12) Patent Application Publication
(10) Pub. No.: US 2016/0225562 A1
(43) Pub. Date: Aug. 4, 2016

(54) ENHANCED CIRCUIT BREAKERS AND CIRCUIT BREAKER PANELS AND SYSTEMS AND METHODS USING THE SAME

(71) Applicant: Unilectric, LLC, Georgetown, TX (US)

(72) Inventors: Jeffrey L. Franks, Tomball, TX (US); Stephen E. Williams, Spring, TX (US)

(21) Appl. No.: 15/009,137

(22) Filed: Jan. 28, 2016

Related U.S. Application Data
(60) Provisional application No. 62/109,349, filed on Jan. 29, 2015.
(60) Provisional application No. 62/134,378, filed on Mar. 17, 2015.

(51) Int. Cl. H01H 47/00; H01H 47/22

(52) U.S. Cl. CPC H01H 47/002; H01H 47/22

(57) ABSTRACT

A circuit breaker system integrated into a package including an input for coupling to an external electrical power source, an output for coupling to an external electrical circuit, and a current path selectively coupling the input and the output. A mechanical circuit breaker mechanism interrupts electrical power flow through the current path in response to a current exceeding a predetermined value. A trip solenoid causes the mechanical circuit breaker mechanism to interrupt electrical power flow through current path in response to a control signal. Voltage and current sensors measure voltage and current values of the electrical power flowing through the current path and a microprocessor selectively generates the control signal in response to the measured voltage and current values, along with and a control profile stored in memory, to energize the solenoid and cause the mechanical circuit breaker mechanism to interrupt the electrical power.

### CROSS-REFERENCE TO RELATED APPLICATION

The present application claims the benefit of U.S. Provisional Applications Ser. No. 62/109,349, filed Jan. 29, 2015, and Ser. No. 62,134,378, filed Mar. 17, 2015, which are incorporated herein by reference for all purposes.

### FIELD OF INVENTION

The present invention relates in general to electrical circuit breakers and in particular to enhanced circuit breakers and circuit breaker panels and systems and methods using the same.

### BACKGROUND OF INVENTION

Electrical power systems, such as those commonly found in private residences and offices, present various hazards to both the surrounding structures and their occupants. These hazards can be significant, including fires and electrocution, which sometimes can be fatal. For example, excess loading on a branch circuit within a home can result in the overheating of wires and the potential for fires. Ground faults, which occur when a low-resistance grounding path is broken and electrical current is forced to take an alternate path to ground, can result in shocks and electrocution. Arc faults, which occur when intermitted contact is made between two conductors, such as at a loose or damaged connection, causes sparks or arcing and also creates the potential for fires.

Traditional thermal-magnetic circuit breaker mechanisms address current overload conditions by tripping (e.g., opening) to break current flow into the branch circuit when the current passing through the circuit breaker exceeds a predetermined rated current. Arc fault circuit interrupter (AFCI) and ground fault circuit interrupter (GFCI) devices are known, but are subject to various drawbacks, including susceptibility to nuisance tripping. While having a single device that can address current overloads, arc faults, and ground faults would have significant advantages, packaging a thermal breaker, AFCI device, and a GFCI device into a single, commercially viable unit is a non-trivial problem.

In addition to protection against various fault conditions, the ability to meter electrical power consumption on a branch circuit within the corresponding circuit breaker would be advantageous, if it could be done in a reliable and commercially cost-effective manner. Furthermore, along with metering, the ability to control individual branch circuits though the individual circuit breakers would allow property owners and managers, as well as utility companies, an increased level of flexibility in the distribution and use of electrical power.

### SUMMARY OF INVENTION

Embodiments of the present invention include a circuit breaker with a low cost embedded microprocessor or microcontroller, which allows the circuit breaker to operate as fully functioning stand alone device, without the need for a major separate control panel or subsystem. Among other things, this circuit breaker is capable of controlling both arc and ground fault conditions, able to quickly identify under load and overload conditions and trip in response, and implement soft-stop and soft-start functions for reducing the risks presented by power surges at the device and utility substation levels. Preferably, the circuit breaker has a form factor and pin arrangement to support direct retrofitting into standard circuit breaker panels.

In a preferred embodiment, the circuit breaker microprocessor/microcontroller is fully programmable from an external device, though either a hardwired or wireless connection. This capability allows the nominal amperage and voltage to be set for a given individual circuit breaker, which in turns allows manufactures, distributors, retailers, and contractors to reduce the diversity of their circuit breaker inventories. For example, in a typical household application, a first circuit breaker or set of circuit breakers may be programmed for use on 110-120 VAC lines with a trip current value of between 1 and 20 amps and a second circuit breaker or set of circuit breakers programmed for use on 220-240 VAC lines with a tripping current between 21 to 50 amps.

The preferred embodiment of the circuit breaker also includes an optical link for communicating with nearby devices, including those disposed within the same circuit breaker panel. The optical link reduces the need for expensive gold plated contacts, which reduces the cost of the circuit breaker and panels while increasing their robustness and practical life span. The optical link also supports an expandable data stream, which allows the circuit breakers and panels to be programmed for additional or new functionality arising in the future.

Furthermore, an embedded microprocessor/microcontroller allows the circuit breaker to be tested to any standard as a standalone product, as necessary to use and sell the circuit breaker worldwide.

Tripping functionality in the preferred circuit breaker embodiment includes a thermal-magnetic circuit breaker mechanism, which trips in response to overload conditions on a branch circuit, a trip solenoid operating in conjunction with the thermal-magnetic mechanism for tripping in response to detected arc and ground faults, and a branch circuit switch (e.g., latching relay or semiconductor switch) for selectively connecting and disconnecting the branch circuit from the power source under processor control, as well as during soft-starts. Under processor control, this configuration allows for faster tripping than traditional thermal-magnetic tripping mechanisms, which is advantageous under arc fault and ground fault conditions. Nuisance trip avoidance may be implemented through the embedded microprocessor/microcontroller.

Moreover, the microprocessor/microcontroller embedded within the preferred embodiment of the circuit breaker enables metering and sub-metering functions, such as real-time branch circuit, receptacle, and appliance power usage measurements.

The present inventive principles are also embodied in a control box for supporting third party communications with individual circuit breakers, as well as circuit breaker panels. This control box supports, for example, electrical distribution command and control functions and the retrieval of electrical data gathered by the individual circuit breakers.

### BRIEF DESCRIPTION OF DRAWINGS

For a more complete understanding of the present invention, and the advantages thereof, reference is now made to the following descriptions taken in conjunction with the accompanying drawings, in which:

FIG. 1A is a functional block diagram of an electrical circuit breaker and communications system according to one representative embodiment of the principles of the present invention;

FIG. 1B is a high level block diagram of a representative deployment of the integrated system of FIG. 1A;

FIG. 2 is a functional block diagram of the electrical supervision hub and communications gateway shown in FIG. 1A;

FIG. 3 is a functional block diagram of the home automation interface module of FIG. 1A; and

FIG. 4 is a functional block diagram of representative circuit breaker interface shown in FIG. 1A;

FIG. 5A is a functional block diagram of a representative electrical circuit breaker shown in FIG. 1A;

FIG. 5B is a more detailed block diagram of the phase voltage and phase current measurement block of FIG. 5A;

FIG. 5C is an electrical schematic diagram of the power supply of 5A;

FIGS. 6A AND 6B are a high level block diagram of the preferred software architecture of the circuit breaker of FIG. 5A;

FIG. 7 is a state diagram illustrating a preferred procedure for determining the operating mode of the circuit breaker of FIG. 5A;

FIG. 8 is a flow chart of a preferred procedure for monitoring the service voltage presented during the use of the circuit breaker of FIG. 5A;

FIG. 9 is a state diagram of the service voltage monitoring procedure shown in FIG. 8;

FIG. 10 is a state diagram illustrating a preferred trip control state machine suitable for use in the circuit breaker of FIG. 5A;

FIG. 11 is a state diagram of preferred remote reset state machine for resetting the circuit breaker of FIG. 5A after a trip;

FIG. 12 is a state diagram illustrating a preferred GFCI control and self-test state machine suitable for use in the circuit breaker of FIG. 5A;

FIG. 13 shows a preferred electrical power metering procedure suitable for use in the circuit breaker of FIG. 5A;

FIG. 14 is a flow chart illustrating a preferred phase correction procedure suitable for use in the electrical power metering procedure of FIG. 13;

FIG. 15 is a block diagram illustrating the preferred user interface of the circuit breaker of FIG. 5A;

FIG. 16 is a block diagram illustrating the communications process through the circuit breaker optical port shown in FIG. 5A;

FIG. 17 is a block diagram of an exemplary bootloader implemented by the circuit breaker embedded processor of FIG. 5A;

FIG. 18 is a flow chart of a preferred system calibration procedure suitable for use in the circuit breaker of FIG. 5A;

FIG. 19 is a preferred ratio error calculation procedure suitable for use in the system calibration procedure of FIG. 18;

FIG. 20 is a preferred phase error calculation procedure suitable for use in the system calibration procedure of FIG. 18;

FIG. 21 is a block diagram of a preferred database suitable for use in the circuit breaker of FIG. 5A; and

FIG. 22 is a state diagram of a set of operations between the database of FIG. 21 and the circuit breaker EEPROM of FIG. 5A.

### DETAILED DESCRIPTION OF THE INVENTION

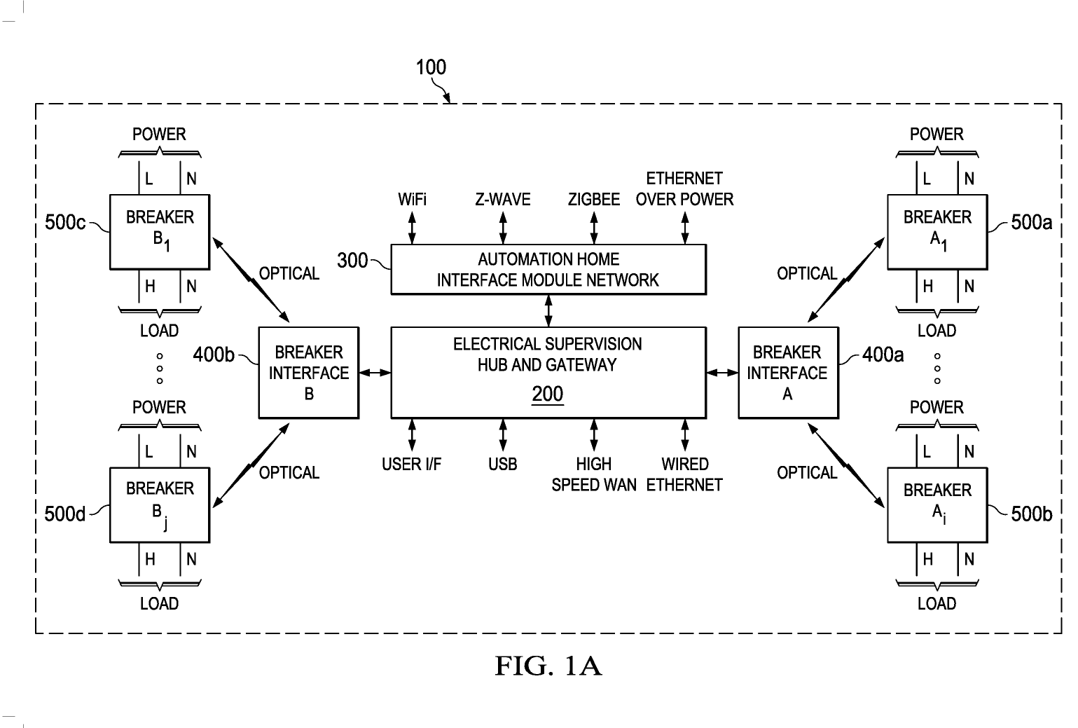

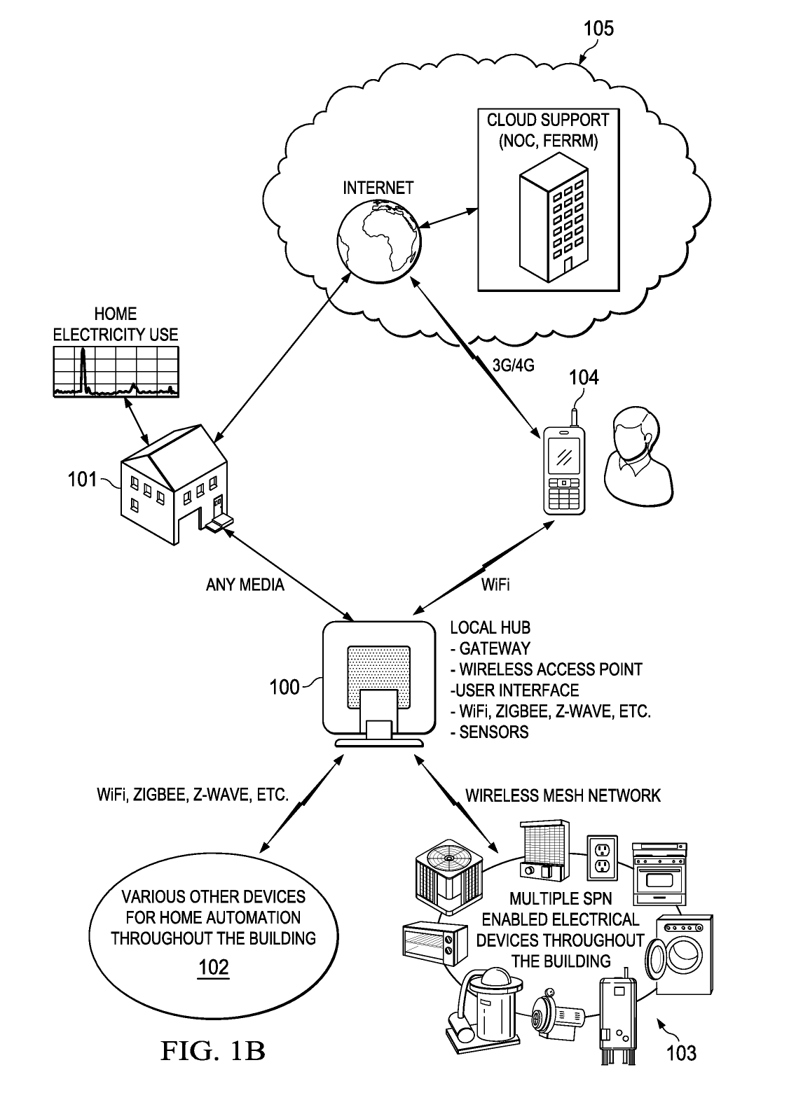

The principles of the present invention and their advantages are best understood by referring to the illustrated embodiment depicted in FIGS. 1-22 of the drawings, in which like numbers designate like parts.

FIG. 1A is a functional diagram of a preferred electrical circuit breaker and communications system 100 according to one representative embodiment of the principles of the present invention. In the embodiment of FIG. 1A, system 100 is disposed within a single electrical circuit breaker panel, although the present principles are not limited to single-panel configurations.

System 100 is based on an electrical supervision hub and gateway 200, which communicates with a home automation network (HAN) interface module 300 and a set of breaker interface units 400a-400b. In turn, breaker interface unit 400a (breaker interface A) communicates via optical links with a set of i number of electrical circuit breakers 500 (where i is an integer index), two of which are shown as 500a and 500b for reference. Similarly, breaker interface unit 400b (breaker interface B) communicates with a set of j number of electrical circuit breakers 500 (where j is an integer index), two of which are shown as 500c and 500d for reference. Each electrical circuit breaker 500 controls a corresponding branch circuit when used in a power distribution (circuit breaker) panel.

As discussed further below, electrical supervision hub and gateway 200 further includes a user interface, Universal Serial Bus (USB) port, high-speed Wide Area Network (WAN) port, and wired Ethernet port. In the embodiment of FIG. 1A, home interface module 300 supports multiple communications protocols including Zigbee, WiFi, Z-Wave, and Ethernet-Over-Power (EOP).

FIG. 1B illustrates a typical deployment of system 100. In this deployment, system 100 communicates using any one or more of the communications media above for monitoring electrical power parameters within a building or structure 101, which may be, for example, a single-family residence, apartment, office, or other commercial or private building or structure serviced by electrical power.

The Wifi, Zigbee, Z-Wave, and EOP capabilities of electrical supervision hub and gateway 200 also support home automation communications and control for a set of electrical devices and subsystems 102. Devices 102 may include, for example, receptacle circuit breakers (discussed further below), appliance circuit breakers (discussed further below), electrical circuit breakers in system 100 or other circuit breaker panel power panel, temperature sensors, fire sensors, gas sensors, CO sensors, earthquake sensors, furnace sensors, air conditioning sensor, air quality sensors (e.g., particulates, toxic gas), motion sensors, gas control devices, and chimney safety devices.

Another set of electrical devices and systems 103 form a wireless mesh network, which preferably communicates through the high-speed WAN port of electrical supervision hub and gateway 200. Mesh communications may be established, for example, between household appliances, air conditioning and heating units, pool electrical equipment, industrial equipment, and office equipment, such as copiers and fax machines.

In addition, the WiFi port of electrical supervision hub and gateway 200 may be used to communicate through a cellular telephone or similar 3G/4G enabled device 104 with the Internet and various Cloud-based services 105. Data collected by electrical supervision hub and gateway 200 may be uploaded to cloud-based services for processing and configuration and control information may downloaded from a cloud-based service to electrical supervision hub and gateway 200.

Advantageously, connectivity to one or more cloud-based services provides for the exchange of environmental information (weather, weather forecasts, and real-time lightening strike data) for use in risk assessment and mitigation. Communications with a cloud-based service also allows for real time monitoring of electrical consumption and changes in usage patterns to determine equipment efficiency changes over time, as well as for evaluating arc fault patterns in a distributed network of intelligent devices (e.g., power panels with embedded controllers, circuit breakers with embedded controllers, and power receptacles with embedded controllers. Cloud services, using information received from integrated system 100, can also apply analytics for predictive safety services.

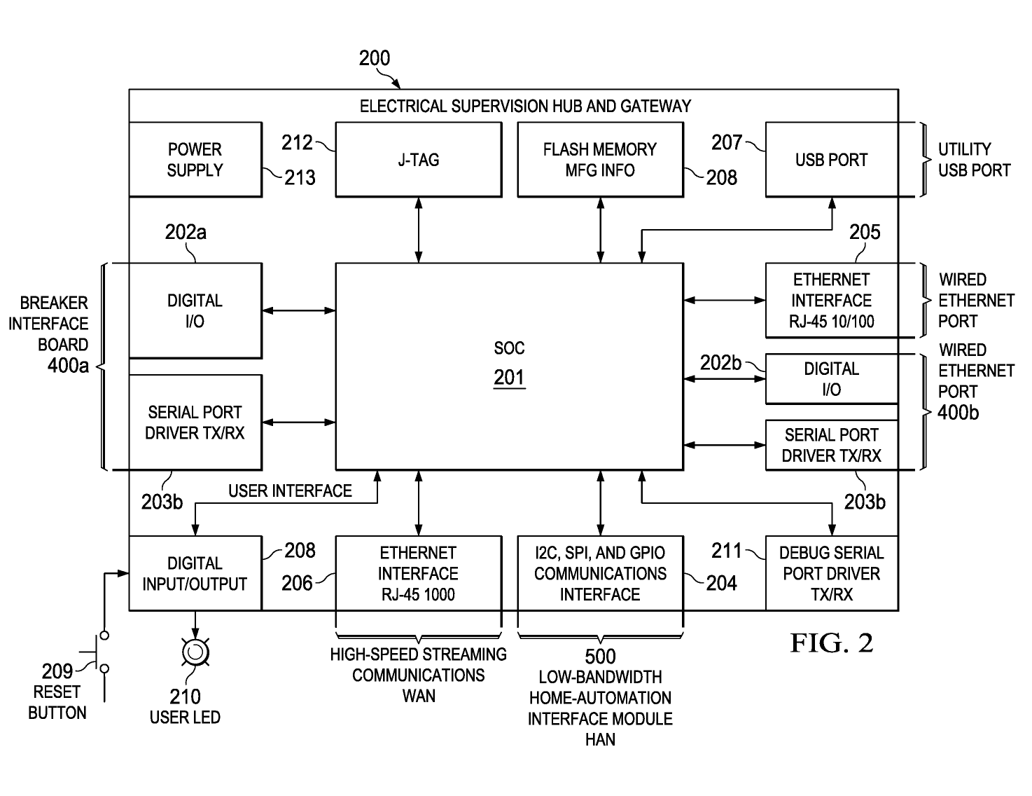

A preferred embodiment of electrical supervision hub and gateway 200 is shown in FIG. 2. In the illustrated embodiment, electrical supervision hub and gateway 200 is disposed on a single printed circuit board, although this is also not a strict requirement for practicing the present principles.

Generally, electrical supervision hub and gateway 200: (1) supports overall building safety, fire and electrical protection, and provides a hub for system and device automation; (2) collaborates with cloud-based services; (3) provides multiple communications connection schemes with multiple local and remote devices and sensors; (4) implements, along with circuit breaker interface units 400a-400b, remote communications infrared optical links to circuit breakers within system 100; (5) aggregates data, event logs, signaling information for delivery to cloud-based services; (6) provides system level data security; (7) provides user level data security; and (8) manages graceful degradation and circuit prioritization policies

More specifically, electrical supervision hub and gateway 200 is based on a system-on-a-chip 201, which communicates with breaker interface units 400a-400b through corresponding digital input/output ports 202a-202b and serial ports 203a-203b. Low-bandwidth communications with HAN interface module 300 are established through a set of communications ports 204, which in the illustrated embodiment include I2C, SPI, and GPIO ports.

A high-speed Ethernet WAN port 206 supports direct wired connections to the Internet and wireless connections through a wireless module. Electrical supervision hub and gateway 200 also includes a lower speed Ethernet port 205.

A USB port 207 allows a service provider, such as an electrical utility company or communications service provider, to configure electrical supervision hub and gateway 200, as well as to access information stored onboard, such as manufacturing and configuration information stored in Flash memory 208. A digital port 208 interfaces with a user interface, which, in the illustrated embodiment, includes a reset button 209 and at least one status LED 210.

Auxiliary ports provided in the illustrated embodiment of electrical supervision hub and gateway 200 include a debug serial port 211 and a J-Tag test port 212. Electrical supervision hub and gateway 200 is supported by a dedicated power supply 213.

Electrical supervision hub and gateway 200 runs an Electrical Supervision and Management Application that supports connections to multiple devices, such as devices 102 and 103 of FIG. 1A. Information collected by electrical supervision hub and gateway 200, can be used in various ways and communicated to external systems for processing. For example, building sensor and device data collected from devices 102 and 103 may be uploaded through high-speed Ethernet WAN port 204 to the Internet and cloud-based safety evaluation services 105 (FIG. 1B). Among other things, the features and patterns extracted from the uploaded data may indicate issues related to building safety, fire hazards, and/or the electrical system, such as potential faults or system degradation, before an actual adverse event takes place.

In addition, cloud-based control services, through electrical supervision hub and gateway 200, can be used by an electric utility or building management for controlling various features of an electrical system and devices and systems connected to system 100. Preferably, electrical system operating directives are passed from cloud-based services to the electrical supervision and management application running on electrical supervision hub and gateway 200 for final disposition and response. The exchange of data between a cloud-base service and electrical supervision hub and gateway 200 related to weather conditions, particularly lightning, and other environmental conditions allow for the optimization of electrical system operation.

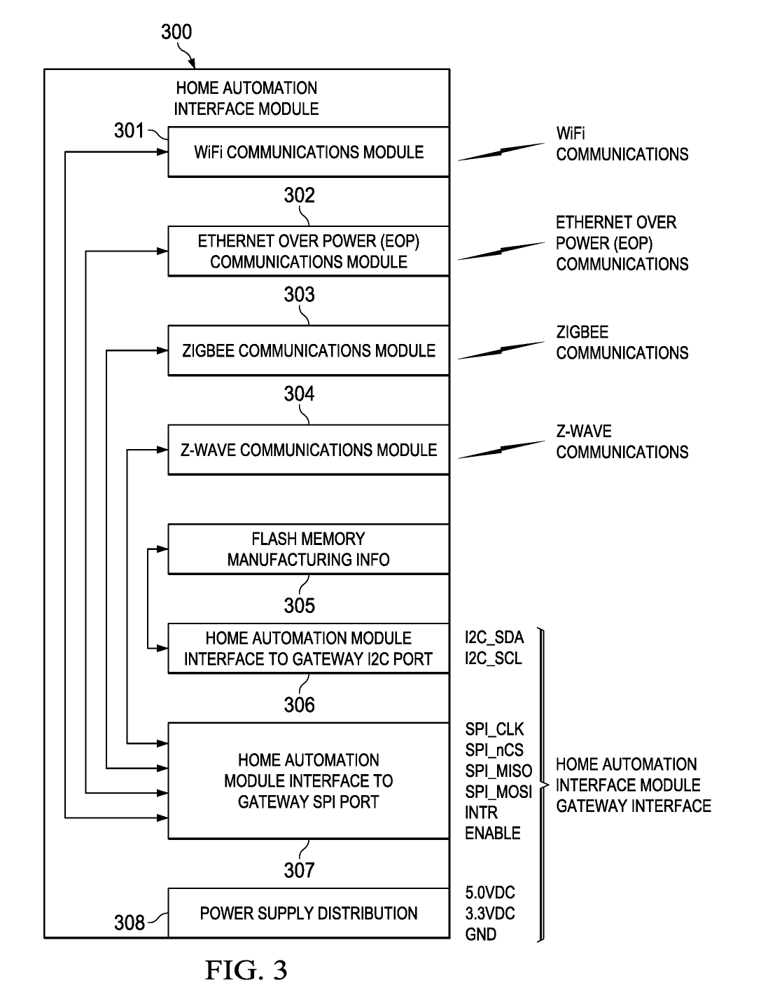

FIG. 3 is a block diagram of home automation network (HAN) interface module 300 of FIG. 1A. In the embodiment shown in FIG. 3, HAN interface module 300 includes a WiFi communications module 301, an Ethernet Over Power (EOP) communications module 302, a Zigbee communications module 303, and a Z-Wave communications module 304. In some embodiments, a BlueTooth module may be included. The type and number of communications modules used in actual embodiments of HAN interface module 300 may vary. For example, most configurations of HAN interface module will include a WiFi communications module 301, with EOP communications module 302, Zigbee communications module 303, and Z-Wave communications module 304 being optional.

HAN interface module 300 also includes Flash memory 305, which communicates with electrical supervision hub and gateway 200 through an I2C port 306, for storing manufacturer's and configuration data. Communications between electrical supervision hub and gateway 200 and WiFi communications module 301, EOP communications module 302, Zigbee communications module 303, and Z-Wave communications module 304 are established through an SPI port 306. Power supply distribution block 307 controls the distribution of 3.3 V and 5 V DC electrical power to the various functional modules, as required for the particular configuration of HAN interface module 300.

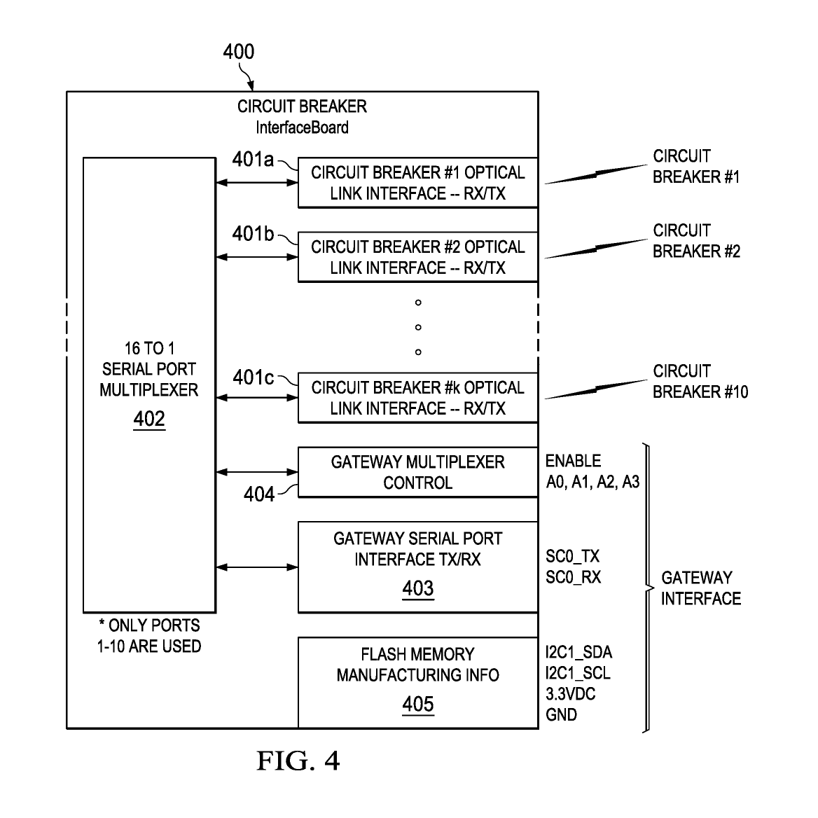

FIG. 4 is a block diagram of one of the circuit breaker interface units 400a-400b shown in FIG. 1A. Each circuit breaker interface unit 400 includes a set receive/transmit (Rx/Tx) optical link interfaces 401, three of which are shown for reference as optical link interfaces 401a-401c. In the embodiment of system 100 shown in FIG. 1A, circuit breaker interface unit 400a includes i number of Rx/Tx optical link interfaces 401 for communicating with i number of circuit breakers 500 and circuit breaker interface unit 400b includes j number of Rx/Tx optical link interfaces 401 for communicating with j number of circuit breakers 500.

Each Rx/Tx optical link interfaces 401 communicates with electrical supervision hub and gateway 200 through a serial port multiplexer 402 and gateway serial port interface 403. Serial port multiplexer 402 is controlled by enable signals received from electrical supervision hub and gateway 200 through gateway multiplexer control port 404.

Manufacturer's and configuration information is stored on each circuit breaker interface unit 400 in Flash memory 405, which is accessible through an I2C interface.

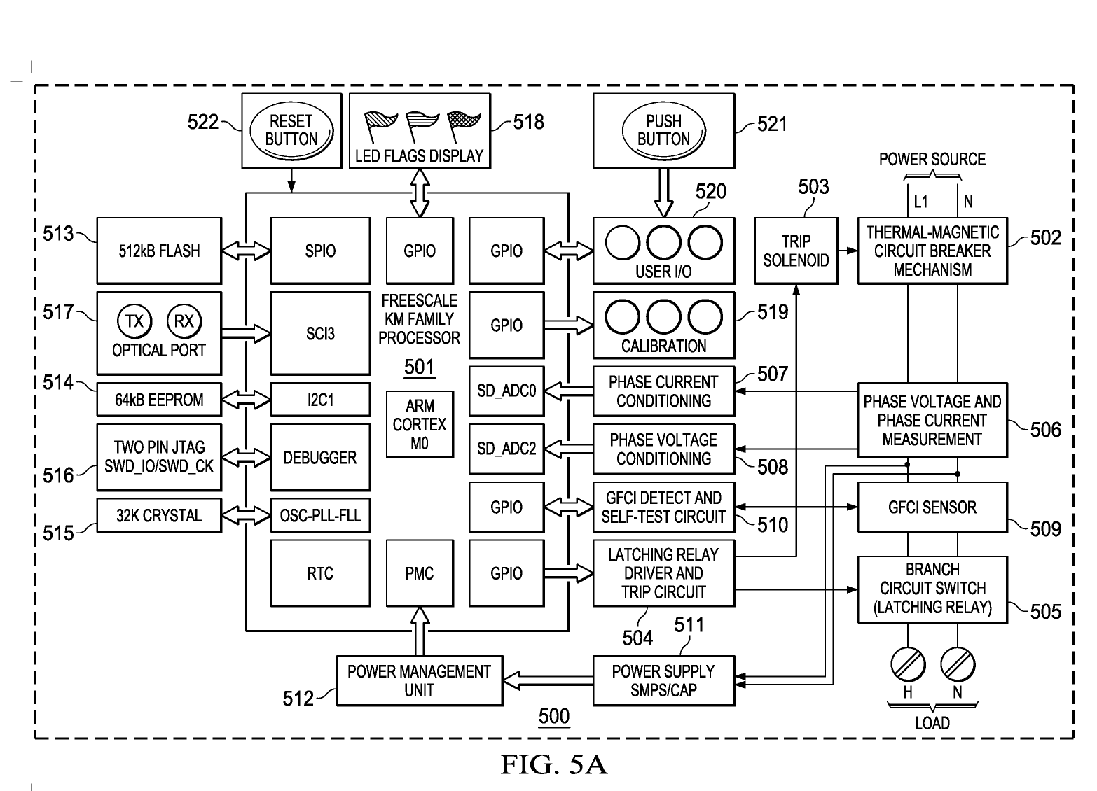

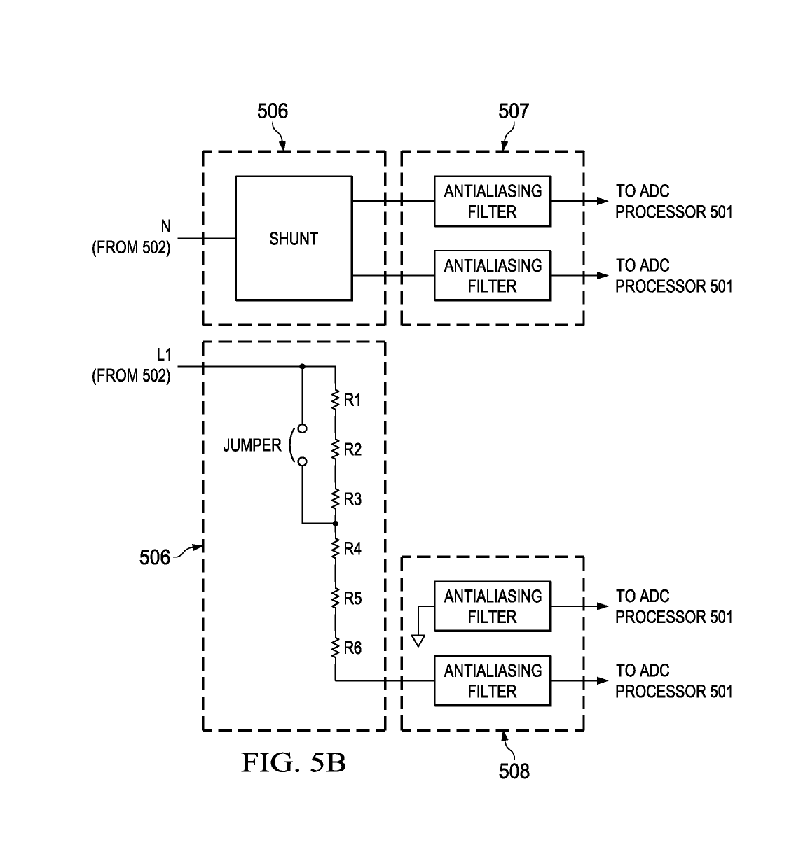

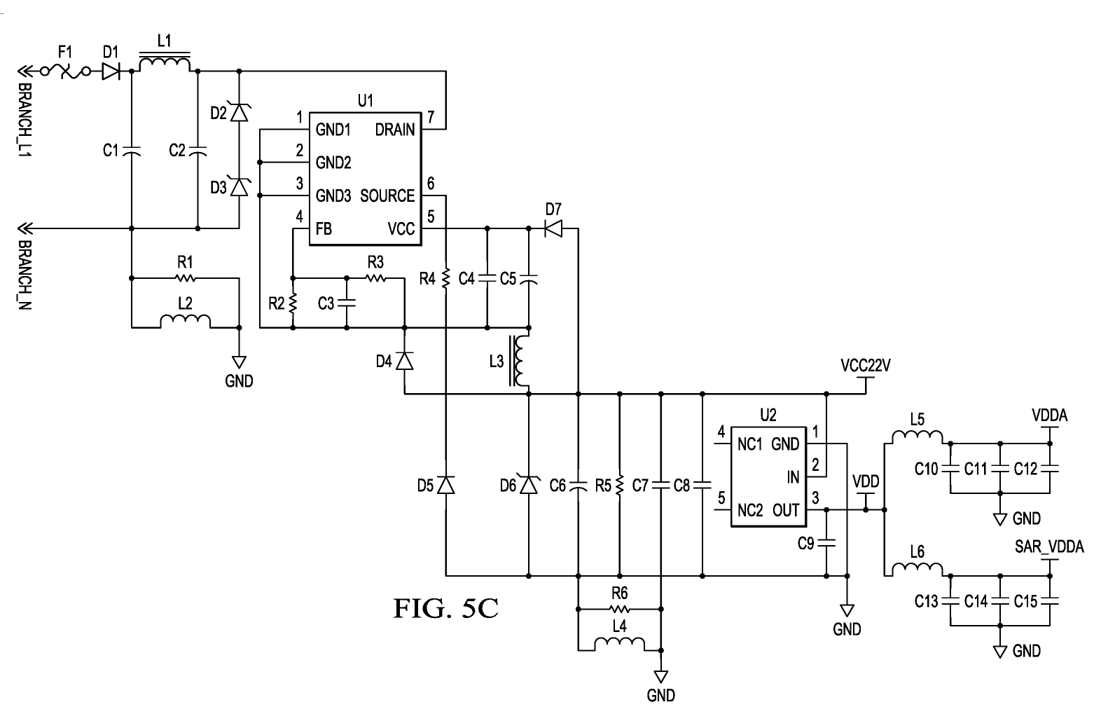

FIG. 5 shows one of the electrical circuit breakers 500 of the embodiment of system 100 shown in FIG. 1A. Generally, electrical circuit breaker 500 can be used a wide range of commercial, multi-tenant, and industrial power panels and configured to operate in conjunction with different electrical power regimes, including single-phase 2-wire (L and N) electrical power at 120/230 volts, single-phase 2-wire (L1 and L2) electrical power at 208/240 volts, single-phase 3-wire (L1-L2, N) at 120/240 volts, three-phase three-wire delta (L1-L3) at 240 volts, and three-phase four-wire wye (L1-L3, N) at 120/208/240 volts. Depending on the country in which electrical circuit breaker 500 is used, the AC frequency can be 50 or 60 Hz.

An embedded processor 501, in conjunction with the internal and external peripherals discussed below, advantageously supports, on an individual electrical circuit breaker basis: (1) meta-data management, including circuit breaker identification, naming, and prioritization; (2) adjustment of electrical parameters, such as trip amps and response time; (3) memory management for saving firmware, setup, configuration, and measurement data; (4) firmware upgrades; (5) sub-metering and status monitoring; (6) remote communications via an infrared optical link; (7) arc and/or ground fault protection; (8) nuisance trip suppressed arc fault detection; (9) the use of external sensor data to mitigate nuisance tripping; (10) branch switch control; (11) soft start on restoration of electrical power after a failure; and built-in branch line test and status monitoring.

The preferred embodiment of electrical circuit breaker 500 implements three primary functions. Primary branch circuit (overcurrent and short circuit) protection is provided by an internal thermal-magnetic circuit breaker mechanism 502. Embedded processor 501 implements enhanced branch circuit protection through a trip solenoid 503 and latching relay driver and trip circuit 504. In addition, embedded processor 501 controls current flow through the branch circuit using branch circuit switch (latching relay) 505 and latching relay driver and trip circuit 504.

Inputs into embedded processor 501 include phase voltage and phase current measurement circuitry 506, phase current conditioning circuitry 507, and phase voltage conditioning 508, discussed further below. Ground fault circuit interrupts (GFCIs) are monitored by GFCI sensors (coils) 509 and GFCI detection and self-test circuitry 510.

Embedded processor is supported by a power supply 511, power supply management unit 512, 512 kB SPI Flash memory 513, 64 kB I2C memory (EEPROM) 514, and 33 kHz crystal 515. A two-pin JTAG port 516 is included for testing and debugging electrical circuit breaker 500.

In a breaker panel embodiment of system 100 of FIG. 1A, embedded processor communicates through an optical port 517 with the corresponding optical port 401 on the associated circuit breaker interface unit 400. A set of LED flags 518 provide status information.

In the illustrated embodiment, embedded processor 501 is one of the Freescale Kinetis-M family of microcontrollers. Among other things, power measurement applications can be run on this family of processors and the members of the family have on-chip peripherals, computational performance, and power capabilities suitable for use in a low-cost and highly integrated power meter built into a circuit breaker. One particular preferred processor is the Freescale MKM34Z128 microcontroller, which is based on a 32-bit ARM Cortex-MO+ core and operates with CPU clock rates of up to 50 MHz The measurement analog front-end is integrated on the chip and includes a highly accurate 24-bit Sigma Delta ADC, PGA, high-precision internal 2V voltage reference (VRef), phase shift compensation block, 16-bit SAR ADC, an accurate Independent Real-time Clock (IRTC), and peripheral crossbar (XBAR). The XBAR acts as a programmable switch matrix, allowing multiple simultaneous connections of internal and external signals.

In addition to high-performance analog and digital blocks, the Kinetis-M microcontroller series is designed to enable a software abstraction layer and integrates the hardware blocks supporting the distinct separation of legally relevant software from other software functions. The hardware blocks controlling and/or checking the access attributes include the ARM Corex-MO+Core, a DMA Controller Module, a Miscellaneous Control Module, a Memory Protection Unit, a Peripheral Bridge, and a General Purpose Input-Output Module

The Kinetis-M devices also support the necessary peripheral software drivers, metering algorithms, communication protocols, and complementary software routines, including various ARM Cortex-MO+ compatible software routines.

Thermal-magnetic breaker mechanism 502 provides protection against current overload and short circuits on the branch circuit and determines the current and voltage rating for electrical circuit breaker 500. For example, in a typical U.S. residential application, the nominal voltage rating would be 120 VAC and the typically current rating 10 or 20 amps, maximum. A single-pole thermal-magnetic breaker mechanism 502 is shown in the embodiment of FIG. 5 for protecting a single-phase, two-wire (L1, N) branch circuit. In alternate embodiments, thermal-magnetic breaker mechanism 502 may be a two-pole device, for use with 2-wire, no neutral (L1, L2) and 3-wire branch circuits (L1, L2, N). For 3-phase systems, thermal-magnetic breaker mechanism 502 may be a three-pole device.

At least with regards to embodiments of circuit breaker 500 used in the U.S., circuit breaker 500 is designed and constructed in accordance with Underwriters' Laboratories (UL) standards UL 489, 943, and 1699 regarding single and multi-pole breaker operation. In addition, at least in the U.S., the internal mechanical layout of the circuit breaker 500 is designed to comply with UL 489 for molded case circuit breakers, and specifically for 240 VAC service, which can also be used for 120 VAC service. Additional mechanical requirements are contained in UL-943 and UL-1699, cover Ground-Fault and Arc-Fault Circuit-interrupters respectively. UL requirements are observed in the mechanical design concerning spacing and clearances between metal parts of same or opposite potential.

Phase voltage and phase current measurement block 506 is shown in further detail in FIG. 5B. As discussed further below, voltage sensing may be configured for 120 or 240 VAC operation by setting circuit board jumpers. Circuit breaker 500 is marked 120 VAC or 240 VAC in accordance the jumper configuration at the time of manufacturing.

Phase voltage and phase current measurement circuitry 506, along with phase voltage conditioning block 508 and phase current conditional block 507 form a metering Analog Front End (AFE), which provides the analog signal sensing and conditioning needed for power meter application. In particular, as shown in FIG. 5B, phase voltage and phase current measurement circuitry 506 includes a shunt in the neutral leg of the branch circuit for measuring phase current. In the illustrated embodiment, the shunt has a nominal resistance of 500 μΩ and provides an output signal range of 0.5 V peak.

The outputs from the shunt are provided to hardware analog anti-aliasing low-pass filters within phase current conditioning block 507, which attenuate signals with frequencies greater than the Nyquist frequency. In the preferred embodiment, the phase current analog anti-aliasing filters have a cut-off frequency of 72.3 kHz and an attenuation of 32.56 dB at the Nyquist frequency of 3.072 MHz. Phase current conditioning circuitry 507 provides inputs into a 24-bit Sigma-Delta (SD) analog-to-digital-converter (ADC) onboard embedded processor 501 through processor port SD_ADC0 (FIG. 5A).

In the illustrated embodiment of circuit breaker 500, embedded processor 501 allows differential analog signal measurements with a common mode reference of up to 0.8 V and an input signal range of ±250 mV. The capability of measuring analog signals with negative polarity advantageously brings a significant simplification to the hardware interfaces to the phase current and phase voltage sensors.

The shunt design of the phase current measurement circuitry advantageously addresses the high dynamic range of the current measurement (800:1 and higher) and the relatively low input signal range (from microvolts to several tens of millivolts) into the ADCs onboard embedded processor 501.

The voltage sense circuit within phase voltage and phase current measurement block 506 is based on a simple voltage divider and a jumper for setting the input voltage to either 120 VAC or 240 VAC, as shown in FIG. 5B. The use of multiple resistors R1-R6 prevents voltage arc-over.

To select a 240 VAC input, the jumper is not used and resistors R1-R6 scale down the input voltage from a 325.26 V peak input line voltage to a 0.2113 V peak input signal. (In one preferred configuration, resistors R1-R6 all have a nominal resistance of 1Ω). To select a 120 VAC input, the jumper is put in place and resistors R4-R6 scale down the input voltage from a 162.63 V peak input line voltage to a 0.2113 V peak input signal.

The output from the voltage divider passed to an analog anti-aliasing low-pass hardware filter within phase voltage conditioning block 508, which are preferably set to a cut-off frequency of 27.22 kHz and an attenuation of 41.05 dB at a Nyquist frequency of 3.072 MHz. Phase voltage conditioning block 508 also includes a dummy anti-aliasing filter as shown in FIG. 5B. The antialiasing filters of phase voltage conditioning block 508 drive the differential inputs of a Sigma-Delta second 24-bit Sigma-Delta ADC on embedded processor 501 through part SD-ADC2 (FIG. 5A).

The digitized Phase current and phase voltage values are processed by embedded processor 501 with a filter-based metering algorithm library. In this regard, the critical tasks of embedded processor 501 are the accurate computation of active energy, reactive energy, active power, reactive power, apparent power, RMS voltage, and RMS current. In the case of the Freescale microcontroller, the metering algorithm library is available from the manufacturer, along with an API that accommodates one-phase, two-phase, and three-phase meter applications.

More specifically, the preferred filter-based metering algorithm performs computations in the time domain with support of Finite Impulse Response (FIR) and Infinite Impulse Response (IIR) digital filters. The algorithm requires only that instantaneous voltage and current samples be provided at constant sampling intervals. The sampling interval is preferably at least 1200 times per second in order to calculate active and reactive energies in the frequency bandwidth up to 10th harmonic. Due to the phase shift introduced into the current measurement, the phases of instantaneous voltage and current samples are aligned with a digital filter.

Sub-metering provides 4-quadrant calculations and measurements as follows: (1) line voltage (VRMS); (2) phase current (IRMS); (3) instantaneous signed active power (W); (4) instantaneous signed reactive power (VAR); (5) instantaneous apparent power (VA); (6) signed active energy (kWh); (7) signed reactive energy (kVARH); (8) active energy pulse number (Imp/kWh); (9) reactive energy pulse number (Imp/kVARh); (10) power factor (PF); and (11) mains frequency (Hz).

Latching relay driver and trip circuit 504 includes a trip solenoid driver for providing power for actuating trip solenoid 503. When the software tripping option is enabled, embedded processor 501 continuously monitors the current through the branch circuit and compares it with a set of trip settings stored in memory, including maximum load current and maximum time. When the branch circuit current exceeds the maximum value for the maximum time, embedded processor 501 actuates trip solenoid 503 through its General Input/Output (GPIO) and the trip solenoid driver within latching relay driver and trip circuit 504. Trip solenoid 503 then mechanically causes thermal-magnetic breaker trip mechanism 502 to trip such that the breaker contacts open and disconnect the protected branch circuit from the power source.

A latching relay driver is also included within latching relay driver and trip circuit 504 for providing power for controlling branch circuit switch (latching relay) 505. Branch circuit switch 505 is controlled by software running on embedded processor 501 through the processor GPIO. Embedded processor 501 implements multiple votes of control, where any vote can cause the branch circuit to be switched off by branch circuit switch 505, although preferably all votes must be unanimous in order to restore power flow from the branch circuit through branch circuit switch 505.

At least four votes of control are used in the preferred embodiment, which include votes for electrical utility (on/off), detected safety issues (on/off), internal override (on/off), and residential user (on/off). The internal override vote is locally generated and controlled inside of circuit breaker 500 and is used for circuit testing and diagnostics, and, when enabled, for nuisance trip suppressed arc fault detection. The electrical utility, detected safety issues, and residential user votes are generated externally and input into circuit breaker 501 through a remote communications infrared optical link and optical port 517.

Limits are imposed on the coils of both trip solenoid 503 and the latching relay of branch circuit switch 505. Hence, the preferred embodiment of latching relay driver and trip circuit 504 uses a constant current source that limits the amount of current driving trip solenoid 503 and branch circuit switch 505. An early warning (“last gasp”) circuit detects when power is lost on the branch circuit, and resets the latching relay of branch circuit switch 505 so that it is initially off when power is restored, which allows circuit breaker 500 to “soft start” following a disruption of the power source.

In particular, the grid equipment of an electrical utility is often subject to potential damage when power is restored after an interruption. Among other things, HVAC systems, refrigeration systems, heaters, and many other devices and systems controlled to the grid typically have automatic control circuits, which cause a higher than normal load to be presented to the grid as power is restored. This higher than normal load can cause inrush and surge currents on the grid, resulting in grid equipment damage, and even further power interruption.

Advantageously, systems using one or more circuit breakers 500 help to prevent grid equipment damage by avoiding a reflection of the entire load to the grid once power is restored. Instead, as power is restored, each embedded controller 501 is programmed to insert a random time delay before each branch circuit switch 505 is closed and the corresponding branch circuit load is energized, which helps reduce inrush and surge currents that can damage grid equipment. In addition, the delay before each branch circuit switch 505 closes helps protect home appliances and equipment connected to the branch circuit from damage caused by unreliable power restore cycles during restoration of grid operations.

The constant current source also sources current to the GFCI self test circuit of GFCI detect and self-test circuit block 510. The GFCI self-test feature is under software control through the GPIO ports of embedded processor 501. When GFCI self-test is asserted, an interface circuit within GFCI detect and self-test circuit block 510 drives an opto-coupled triac, which unbalances the current through GFCI sensing coils 509 to artificially generate a GFCI event.

Power supply 511 takes a universal input of 85-265 VAC from the branch circuit and outputs 22 VDC for circuit breaker control. A linear regulator provides 3.3 VDS to the power management controller of embedded processor 501. Power management unit 512 supplies the circuit breaker electronics from either 50 Hz or 60 Hz VAC on the branch circuit. Advantageously, power supply 511 and power management unit 512 allow circuit breaker 500 to be used worldwide, with service voltages of either 120 or 240 VAC nominal and at either 50 or 60 Hz.

In the illustrated embodiment shown in FIG. 5C, power supply 511 is a non-isolated buck SMPS power supply based on an NXP TEA1721AT SMPS controller (U1). This is a low cost design that uses low wattage (<3.0 W). Metering in the circuit breaker must be capable of working with a universal input voltage range of 85 VAC to 265 VAC. Hence, a buck configuration is preferred given that it handles a wide range of input voltages (e.g., 85 VAC to 500 VAC), uses lowest cost semiconductors making the overall solution less expensive, has a high conversion efficiency because of the combination of frequency and peak current modulation, and consumes ultra low standby power of approximately 75 mW. The overall characteristics of power supply 511 for the illustrated embodiment are provided in Table 1 of the Appendix.

The input stage generally includes, in series with the hot (L1) line of the branch circuit, a fusible resistance F1, input rectification diode D1, and coil L1. A bulk electrolytic filter capacitor C1 couples the input to coil L1 to the neutral line (N) of the branch circuit and a main bulk electrolytic capacitor C2 couples the output of coil L1 to the branch circuit neutral line. The combination of coil L1 and capacitor C1 form the input line filter network. A pair of stacked Zener diodes (D2, D3) between the neutral and hot lines at the L1 coil output provide surge voltage protection. A ferrite L2 and resistor R1 between the neutral line a ground are included for noise filtering.

The fusible input resistance provides at least three important functions: (1) acts as a fuse in case of any short in the power supply; (2) controls the inrush current going into bulk capacitors; and (3) aids in differential mode attenuation. As it has to perform these three functions, a flame proof film type resistance or WWR surge resistance is preferably used. In the illustrated embodiment, the fusible input resistance has a nominal resistance of 47 Ohms.

Regulation IEC 61000-4-5 defines a surge immunity test as high power spikes caused by large inductive devices in mains. In general, a circuit under test is presented with a train of short duration (1.2 to 50 μs) but high voltage (i.e., up to 4 kV) pulses applied between branch circuit hot (L1) and neutral (N) inputs. Theses pulses are applied at different phase angles of the ac voltage (e.g., 0°, 90°, 180°, 270°, 360°). The pulses typically cause high inrush current, which quickly charges the storage capacitor in a standard SMPS. The major risk is therefore overvoltage for the input components, including the bulk capacitors, the rectifier diode and the SMPS regulator integrated circuit.

In circuit breaker 500, fusible resistor F1 and the rectifier diode D1 control the inrush of current in response to surges on the branch circuit, with the Zener diodes D2 and D3 absorbing a part of the energy and bulk capacitors C1 and C2 absorbing the rest. This configuration advantageously limits peak energy to which the bulk capacitors C1 and C2 and the following components are exposed. In addition, since the input AC voltage can spike higher than 265 VAC, Zener diodes D2 and D3 are selected to withstand voltage transients up to the 4-kV level.

The output ground of the system is the same as the input neutral with the exception of the L2-R1 noise filter, such that the combination of diode D1, capacitors C1 and C2 and coil L1 form a half-wave rectifier. Since the input AC voltage can go as high as 282 VAC before clipping by Zener diodes D2 and D3, the DC voltage can reach levels of up to 400 VDC, which bulk capacitors C1 and C2 must be able to sustain such In the illustrated embodiment, net capacitance of 4.5 uF per Watt of output power was chosen, with capacitors C1 and C2 both being 6.8 μF 400 V capacitors. Diode D1 was chosen to be a 1 A, 1000V S1M diode. Filter coil L1 has a nominal inductance of 1 mH and an RMS current rating of 250 mA.

The voltage divider consisting of resistors R2 and R3 sets the output voltage regulation point of the buck converter. Resistor R4 is the output current sensing resistor and resistor R5 is the pre-load resistor. Exemplary resistance nominal values are 1.69 S2 for resistor R4, 2.43 kΩ for resistor R2, 18.0 kΩ for resistor R3, and 240 kΩ for resistor R5. Coil L3 was chosen to have the characteristics shown in Table 2 of the Appendix. An exemplary resistance value for resistor R4 is 1.69 S2 nominal, and exemplary nominal capacitance values for capacitors C3, C4, and C5 are respectively 10 μF, 100 nF, and 10 μF.

A VDD capacitance (C6) of 330 uF was chosen to ensure a small peek-to-peek noise level on the 22 V VDD supply line, with Zener diode D6 providing over-voltage protection at 22V. An exemplary nominal inductance value for filter inductor L4 is 1 pH (nominal), an exemplary nominal resistance value for resistor R5 is 240 kΩ, and an exemplary capacitance value for both capacitors C7 and C8 is 100 nF (nominal).

A supply voltage is 3.3 V is required for powering the preferred embedded processor 501 and its peripherals. As metering operations are performed at 3.3 V and 2-3 mA with no load, a Texas Instruments TLV70433DBVR linear voltage regulator (U2) with quiescent current of 3.2 μA was chosen to minimize standby power.

Appropriate filtering is used to obtain accurate 24 bit sigma-delta A/D conversions in the embedded processor 501. The filtering network includes capacitors C9-C15, and inductors L5 and L6 In the illustrated embodiment, capacitors C9-C15 each have a nominal capacitance value of 100 nF and inductors L5 and L6 each have a nominal inductance of 1 pH.

All the digital circuits are supplied from the VDD, VDDA, and SAR_VDDA voltages shown in FIG. 5C. The digital voltage (VDD), which is inactive if the power meter electronics are disconnected from the mains, supplies embedded processor 501, SPI FLASH 513, I2C EEPROM 514, the isolated open-collector pulse output interface, and optical port 517.

A power supply monitor within power management unit 512, which in the preferred embodiment is a simple resistive voltage divider, provides an early warning (“last gasp”) signal to embedded processor 501 indicating that power supply 511 has lost power such that a power failure interrupt handling routine can be initiated and parameters and data saved to memory before power is completely lost.

In the illustrated embodiment, 512 kB SPI Flash memory 513 stores new firmware applications and/or load profiles and connects to the SPIO port of embedded processor 501, which supports a communication speed of up to 12.5 Mbit/s. 64 kB I2C EEPROM 514 stores, among other things, parameters and load profiles and connects to embedded processor 501 through an I2C connection configured for a baud rate of 100 kHz.

External crystal 515 in the illustrated embodiment of circuit breaker 500 is a 32.768 kHz crystal and directly generates the RTC onboard embedded processor 501. In addition, the output from crystal 515 multiplied by frequency locked loops and phase locked loops, also onboard embedded processor 501, to provide clocks signals to the processor core, bus. and peripherals.

JTAG port 516 preferably employs a two-pin mini JTAG connector supporting testing of subsystems onboard embedded processor 501 through the processor debugging port.

Optical port 517, which communicates with optical link interfaces 401 on the corresponding circuit breaker interface board 400, galvanically isolates circuit breaker control and power metering in accordance with the IEC 107/ANSI/PACT standard. In the illustrated embodiment, optical port 517 is an IR interface, which is driven by a UART3 module on embedded processor 501.

LED status flags 518 include red and green LEDs for signaling the status of circuit breaker 500. In the illustrated embodiment, LED status flags are driven through the GPIO of embedded processor 501 under software control. When the green LED is light, the breaker status is OK. Constant illumination of the red LED indicates an overcurrent trip, while a blinking red LED indicates an arc fault trip. Switching between the green and red LEDs, which generates a blinking yellow signal, indicates a ground fault trip.

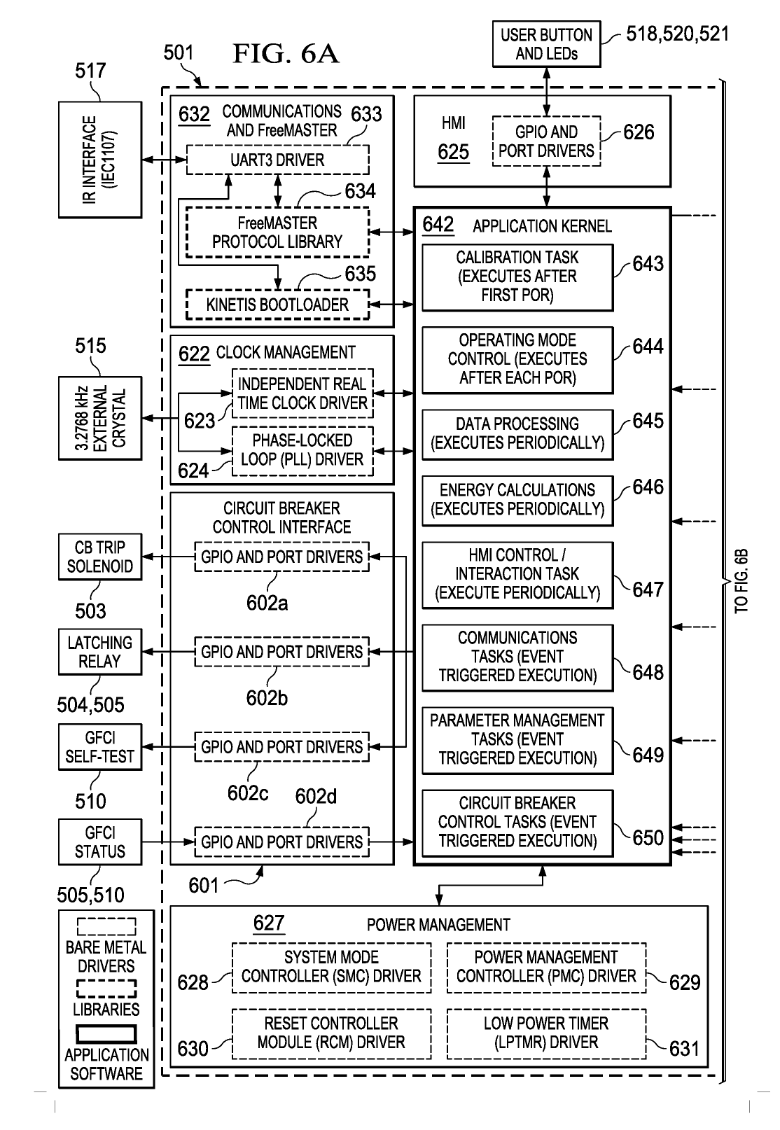

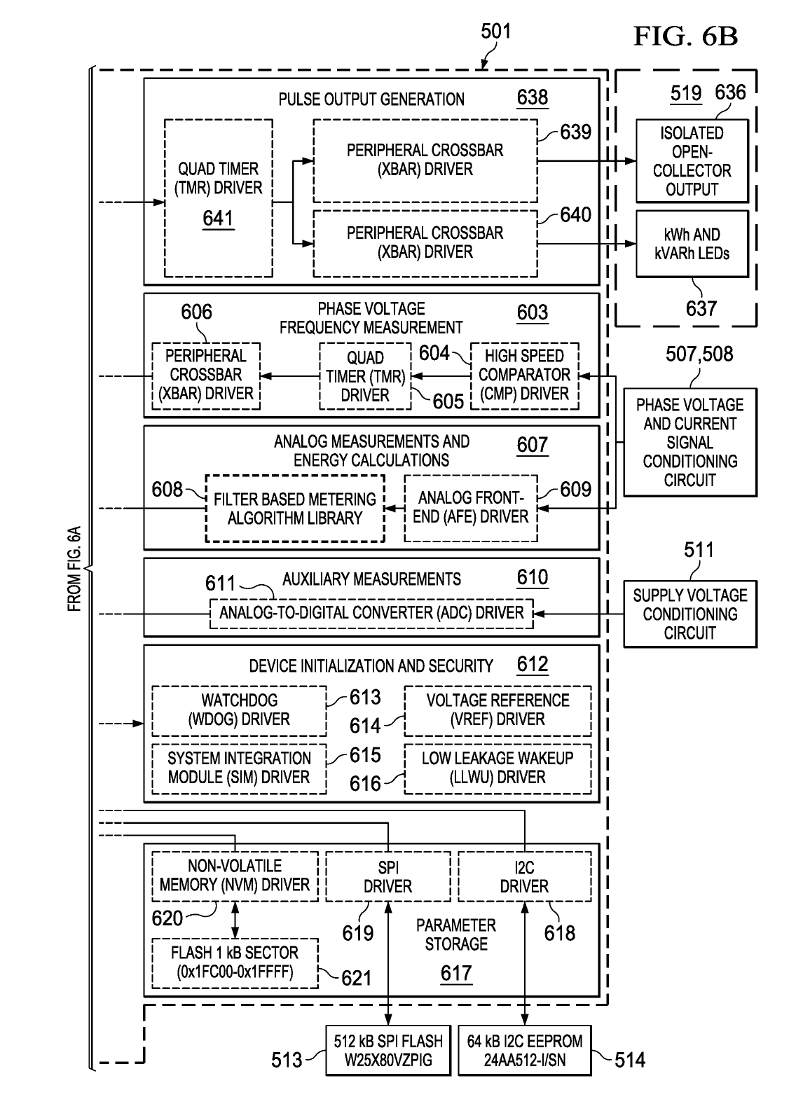

Calibration block 519 includes output calibration LEDs kWh and kVARh, which are controlled from two timer channels of embedded processor 501. In the illustrated embodiment, the timer outputs are each routed through a respective GPIO and the peripheral crossbar module, which interconnects internal and external logic signals (see FIG. 6B). The timers are chosen to produce a low-jitter and high dynamic range pulse output waveform.

Calibration block 519 also includes an isolated open-collector pulse output interface, which in the illustrated embodiment is controlled through the embedded processor crossbar and may be used for switching loads with a continuous current up to 50 mA and a collector-to-emitter voltage of up to 70 V. Advantageously, since the isolated open-collector interface is driven by the peripheral crossbar, it may be controlled by various signals within embedded processor 501, such the timer channels.

The Human Machine Interface (HMI) includes a user I/O 520 communicating with the embedded processor GPIO and a user push button 521. User I/O 520 includes a software-driven user LED, which blinks when the power meter function enters the calibration mode and turns solid after the power meter function is calibrated and operating normally. User push button 521 supports a wakeup function for circuit breaker 500.

A reset button 522 allows for a hardware reset of circuit breaker 500 through the reset pin of embedded processor 501.

The illustrated embodiment of circuit breaker 500 does not include an LCD as part of the HMI. However, the SWD interface of the preferred embedded processor 501 can be used to drive four ceramic capacitors as a charge pump, which in turn drive an LCD device.

FIGS. 6A-6B are high level block diagrams of the preferred software architecture of circuit breaker 501 including the application kernel, the bare-metal drivers that interface embedded processor 501 with the hardware blocks discussed above in conjunction with FIG. 5, and the algorithm libraries. For discussion purposes, a single-phase embodiment of circuit breaker 501 is assumed, although the same principles may also be applied to multi-phase circuit breakers in alternate embodiments. As discussed above, embedded processor 501 in the preferred embodiment of circuit breaker 500 is a Freescale MKM34Z128 device, which also forms the basis for the following discussion.

In the illustrated embodiment, the primary software modules manage and control hardware resource allocation, interrupt priority, electrical measurements, circuit breaker functions, the user interface, optical communications, a bootloader, circuit breaker systems calibration, and the database. The software architecture is based on a kernel (QMX) running on embedded processor 501 in response to a 12.28 MHz system clock generated from an external RTC clock source (crystal 515, FIG. 5A) and a PLL.

The application software is written in the C-language and compiled using the IAR Embedded Workbench for ARM processors with full optimization for execution speed. In the preferred embodiment, the software application code operates in conjunction with the Freescale Kinetis-M bare-metal software drivers and filter-based metering algorithm library. A real-time operating system (RTOS) QMX from Freescale is also used in this implementation.

Preferably, the software executes transitions between operating modes, performs power meter calibration after first start-up, calculates all metering quantities, controls the active and reactive energies pulse outputs, manages the HMI (LEDs 520 and push-button 521), stores and retrieves parameters from non-volatile memory, allows application remote monitoring and control, and executes specialized circuit breaker application code. Application monitoring and control is performed through Freescale's FreeMASTER communications library. Metrology is accomplished using Freescale's filter-based metering algorithm library, which calculates metering quantities in the time domain.

Calibration data are stored in Flash memory onboard embedded processor 501 and does not change. Manufacturing data are stored in external EEPROM 514. External Flash memory 513 is used for firmware updates under management of the bootloader discussed below, as well as the storage of persist logging data, persist parameter and setup values, and persist metadata.

Circuit breaker 500 supports descriptive data (metadata) in the form of collections of key/value pairs that can be adjusted at run-time without reprogramming. Key/value pairs can be added and deleted, such that new categories of information not anticipated at time of manufacture can be supported. In the preferred embodiment, the minimal key/value collections consist of at least an identification number, identification long name, identification short name, and demand-response prioritization.

The data type for both the key and the value of the key/value pairs is a UTF-8 null terminated string. In the preferred embodiment, the metadata collections support operations including returning a list of key/value pairs, specifying list ordering, appending a new element to the list, removing an element from the list, and returning an index to a list element.

The processor architecture shown in FIGS. 6A and 6B allows firmware to be updated after circuit breaker 500 has shipped from the manufacturer, for example, to add features address bugs, provide customization for the end-user.

As discussed further below, the illustrated embodiment of circuit breaker 500 implements a bootloader supporting field firmware upgrades. Advantageously, the bootloader provides for reliable firmware upgrades, including the ability to recover from errors during the upgrade process.

Logging data are stored in a circular buffer that provides backup in the event that communications with the server is lost. Status flags track the over-writing of data within the circular buffer.

As shown in FIG. 6A, circuit breaker control interface module 601 includes a bare-metal GPIO and port driver 602a interfacing with trip solenoid 503, a bare-metal GPIO and port driver 602b interfacing with latching relay 505 and latching relay driver circuit 504, a bare-metal GPIO and port driver 602c interfacing with the GFCI self-test circuit of hardware block 510, and a bare-metal GPIO and port driver 602d interfacing with GFCI sensor 509 and the GFCI detect circuitry of block 510.

Phase voltage conditioning circuitry 507 and phase current conditioning circuitry 508, along with the hardware ADCs on embedded processor 501, interface with a phase voltage frequency measurement software module 603 and an analog measurement and energy calculations software module 607. Phase voltage frequency measurement module 602 includes a high speed comparator (CMP) bare-metal driver 604, quad timer (TMR) bare-metal driver 605, and peripheral crossbar (XBAR) bare-metal driver 606. Analog measurement and energy calculations module 607 includes an analog front-end (AFE) bare-metal driver 609 and filter-based metering algorithm library 608.

Measurements made using conditioned supply voltages VDDA and SAR VDDA output from power supply 511 (FIG. 5C) are processed through auxiliary measurements module 610, which includes bare-metal analog-to-digital converter (ADC) driver 611.

Device initialization and security module 612 includes bare-metal watchdog (WDOG) timer driver 613, voltage reference (VREF) bare-metal driver 614, bare-metal system integration module (SIM) driver 615, and low-leakage wakeup (LLWU) bare-metal driver 616.

Parameter storage module 617 provides the interface with both onboard and external nonvolatile memory. In particular, external I2C EEPROM 514 interfaces with bare-metal 12C driver 618 and external SPI Flash 513 interfaces with bare-metal SPI driver 619. A nonvolatile memory (NVM) bare-metal driver 620 provides an interface to an onboard Flash memory sector 621.

External crystal 515 (FIG. 6B) interfaces with a clock management module 622, which includes bare-metal independent real time clock driver 623 and phase locked loop (PLL) bare-metal driver 624.

The HMI, which includes LED flags 518, user I/O 520 and push button 521 of FIG. 5A, interfaces with HMI module 625. HMI module 625 includes bare-metal GPIO and port drivers 626.

Power management module 627 includes bare-metal system mode controller (SMC) driver 628, bare-metal power management controller (PMC) driver 629, reset controller module (RCM) bare-metal driver 630, and low power timer (LPTMR) bare-metal driver 631.

IR hardware interface 517 is associated with communications and FreeMaster module 632, which includes bare-metal UART3 driver 633, FreeMaster protocol library 634, and Kinetis bootloader 635.

Pulse output generation module 638 provides an interface to isolated open collector hardware output 636 and kWh and kVARh LEDs 637 of calibration block 519 of FIG. 5A. Pulse output generation module 638 includes bare-metal quad timer (TMR) driver 641 and bare-metal peripheral crossbar (XBAR) drivers 639 and 640.

The software architecture of FIG. 6 is based on application kernel 642 (FIG. 6A), which includes calibration task module 643 and operating mode control module 644. In the preferred embodiment, calibration task module executes after the first power on reset (POR) and operating control module 645 executes after each POR.

Data processing module 645, energy calculations module 646, and HMI control/interactions task module 647 all execute periodically. Application kernel 642 also includes communications tasks module 648, parameter management tasks module 649, and circuit breaker control tasks module 650, all of which are event triggered.

Table 3 summarizes the operating parameters for an embodiment of circuit breaker 500 adapted for controlling and metering a single-phase residential branch circuit. For the preferred embodiment of circuit breaker 500, Table 4 summarizes the primary software tasks, Table 5 summarizes the allocation of hardware resources typically called on by embedded processor 501, and Table 6 lists the interrupt priorities assigned to those resources.

Generally, circuit breaker 500 implements multiple branch circuit protective functions, including: (1) over-current protection, as set by thermal-magnetic breaker mechanism (with the tripping amperage preferably labeled on the exterior of the circuit breaker case); (2) false trip suppressed arc fault interruption, which is optionally enabled through software, latching relay and trip circuit 504, and trip solenoid 503; (3) ground fault interruption (optionally enabled); (4) adjustable trip current and response time (optionally enabled); and (5) external safety signal based trip (optionally enabled).

The illustrated embodiment of circuit breaker 500 supports at least two operating modes, one of which is automatically selected at run time. Specifically, the stand-alone mode is selected when a communications link is not available and the remote mode is selected when a communications link is available.

In the stand-alone mode, the functionality of circuit breaker 500 depends on the operational parameters that are currently programmed into Flash memory 513. In the illustrated embodiment, the programmable operations available for the stand-alone mode include: (1) arc fault enable (on/off); (2) ground fault enable (on/off); (3) adjustable over-current trip enable (on/off); (4) adjustable over-current trip value (amps); and (5) adjustable over-current trip response time (seconds).

In the remote mode, the programmable operations generally include the following in the illustrated embodiment: (1) adjustment of trip parameters; (2) management of meta-data; (3) branch circuit switch control; (4) use external sensors enable; (5) firmware upgrade operations; (6) management of sub-metering report schedules; (7) obtaining sub-metering status and measurements on command or by schedule; (8) management of built-in branch line test and status; (9) retrieval of circuit breaker manufacturing data; (10) setting the calendar and real-time clock; (11) setting calibration parameters; (12) software reset; (13) clearing energy counters; and (14) sending remote commands.

The adjustable trip parameters function allows for particular features to be selectively enabled and disabled, as well as for certain electrical parameters to be varied, from a remote terminal. In the illustrated embodiment, this function supports: (a) arc fault enable/disable (on/off); (b) ground fault enable/disable (on/off); (c) adjustable trip current enable/disable (on/off); (d) adjustable trip current value variation (amps); and (e) adjustable trip response time variation (seconds).

The metadata management function allows for the remote access and control of metadata onboard circuit breaker 500, including: (a) retrieving the value of a meta-data element by key; (b) retrieval of a list of all meta-data element key-value pairs; (c) the addition of a new key-value pair; (d) the deletion of a key-value pair; (e) the modification of a key-value pair; and (f) the movement a key-value pair up or down in the list.

The branch circuit switch control functionality allows for the assertion of the stop and restart votes discussed above, including: (a) the electric utility vote (on/off); (b) the safety issues vote (on/off); (c) the internal override vote (on/off); and (d) the residential user vote (on/off).

The external sensors enable function allows circuit breaker 500 to be turned on and off in response to externally generated data. The manage sub-metering report schedules function provides for: (a) the retrieval of a list of sub-metering schedules; (b) the addition of a sub-metering schedule; and (c) the deletion of a sub-metering schedule.

The manage built-in branch line test and status function provides for: (a) the retrieval of test results from circuit breaker 500; and (b) the running of another test. The retrieval of circuit breaker manufacturing data function supports the remote access of manufacturer data including: (a) model number; (b) serial number; (c) lot number; (d) date stamp; (e) voltage configuration; (f) over-current rating; (g) phase configuration; and (h) firmware version.

The circuit breaker control function implements various features, including determining the operating mode (i.e., stand-alone or remote), monitoring the service voltage (e.g., brown-out, nominal-unstable, nominal-stable, or over-voltage), Managing soft-start operation, managing branch circuit switch control (i.e., latching relay 505), and handling trip events.

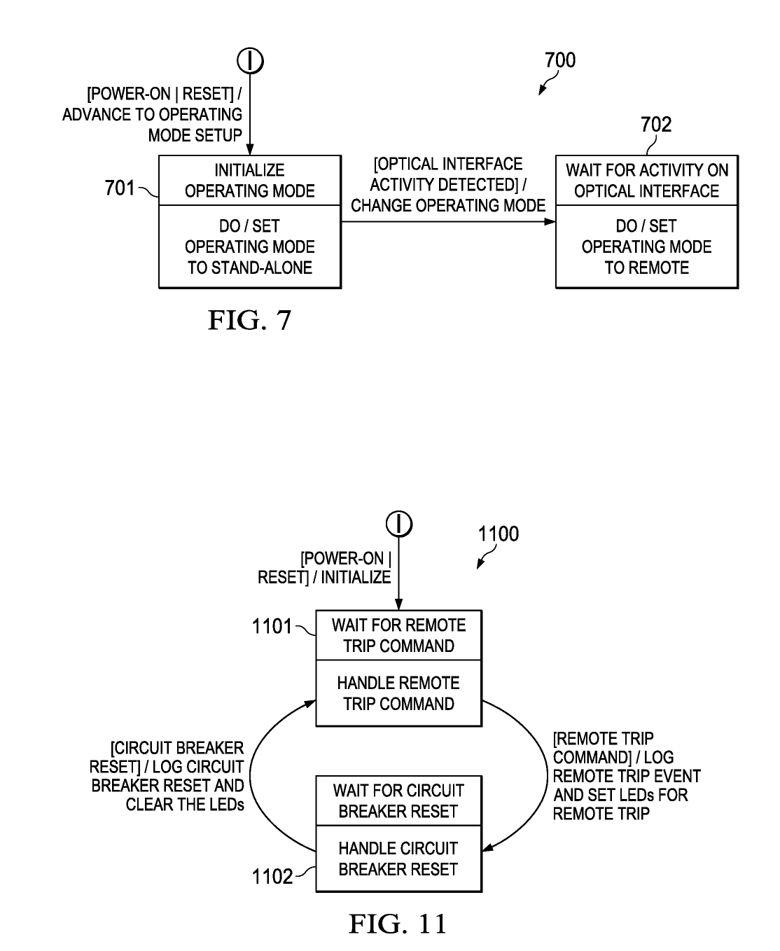

FIG. 7 is a state diagram illustrating a preferred procedure 700 for determining the operating mode of circuit breaker 500. In the illustrated embodiment, procedure 700 is executed by operating mode control module 644 of application kernel 642 of FIG. 6A in response to reset controller module driver 630 of power management module 627.

On power-on or after a reset, embedded controller 501 initially sets the operating mode to the stand-alone mode (State 701). As discussed above, in the stand-alone mode, circuit breaker 500 is controlled by the parameters already stored in nonvolatile memory, which may have been programmed at the factory or in the field by a technician. In other words, the stand-alone mode, and the parameters in nonvolatile memory, set the default operations for circuit breaker 500.

If and when embedded processor 501 detects activity on optical interface 517, circuit breaker 500 enters the remote mode discussed above (State 702). Thereafter, the parameters stored in nonvolatile memory (e.g., Flash memory 513 and/or EEPROM 514) may be changed by remote means via the optical interface.

Additionally, once in the remove mode, circuit breaker 500 can be setup to send energy measurements, circuit breaker status, or setup parameters to a remote device, for example electrical supervision hub and gateway 200 of FIG. 1A. Conversely, a device such as electrical supervision hub and gateway 200 can send commands to circuit breaker 500 for controlling the availability of power through circuit breaker 500 by setting or releasing latching relay 505. Furthermore, an external device, such as electrical supervision hub and gateway 200, can also send a remote trip command to circuit breaker 500 for triggering trip solenoid 503 and tripping thermal-magnetic circuit breaker mechanism 502 (FIG. 5A).

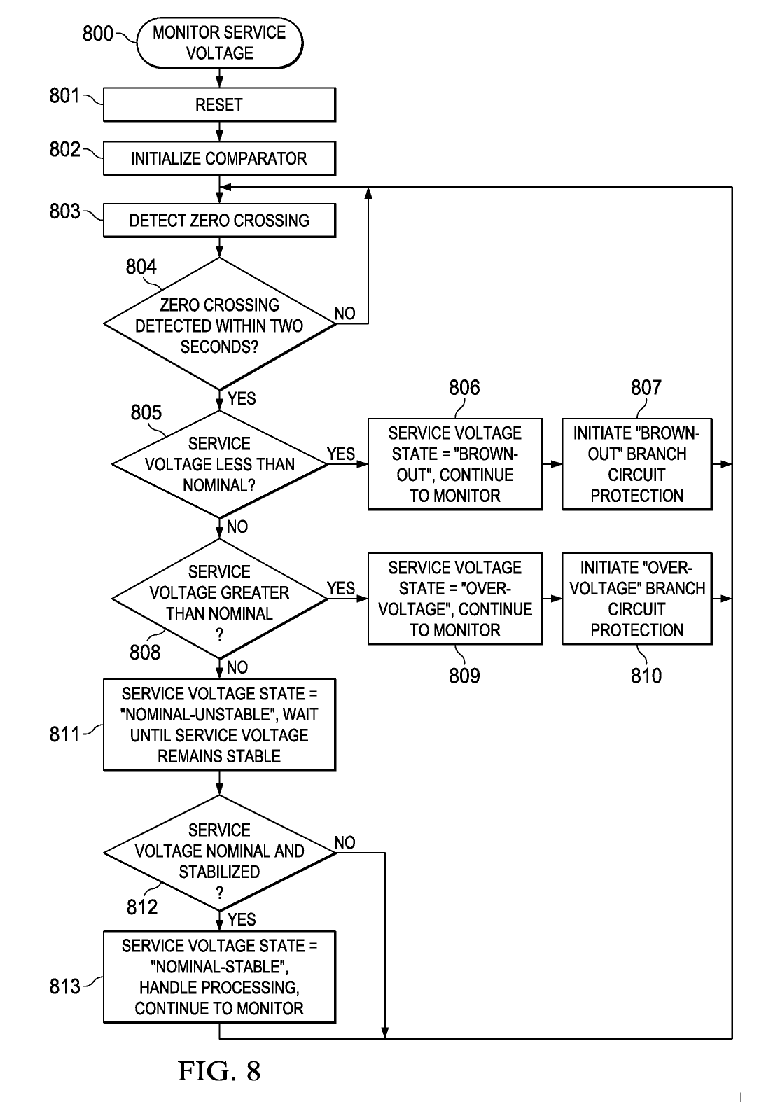

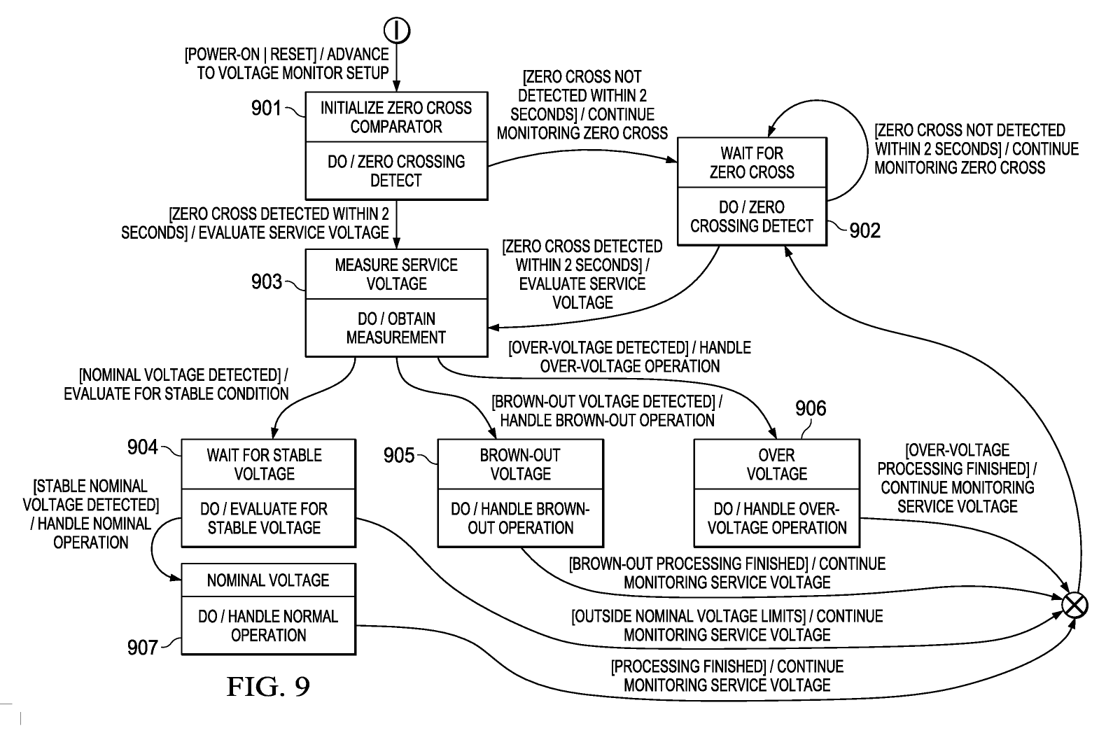

A procedure 800 for monitoring the service voltage is described in the flow chart of FIG. 8 and the state diagram of FIG. 9. Generally, the service voltage (e.g., the voltage at the L1 and N1 lines of FIG. 5A) is monitored to determine whether it is within a nominal range in order to safely apply power to the branch circuit associated with circuit breaker 500. In particular, latching relay 505 is kept open, for example on new service start-up or after power restoration following a disruption, until the service voltage is stable. Once the service voltage is stable, latching relay 505 (FIG. 5A) is closed to energize the branch circuit associated with circuit breaker 500.

In addition, by continuously monitoring the service voltage, additional actions may be triggered to protect electrical devices and equipment connected to the branch circuit. For example, electrical devices can be damaged due to “brown-out” conditions or “over-voltage” conditions. When either of these conditions is detected, latching relay 505 can be opened to prevent damage to electrical devices powered by the controlled branch circuit. Table 7 is a service voltage state table indicating the brown-out and overvoltage conditions for 120 VAC and 240 VAC nominal electrical services.

At Block 801, circuit breaker 500 resets either at power-on or after an active reset, as processed by reset controller module driver 630 of power management module 627. A zero crossing comparator function of circuit breaker control tasks module 650 of applications kernel 642 (FIG. 6A) is initialized at Block 802. At Block 803, circuit breaker 500 is in the zero crossing detection mode (State 901) and embedded processor 501 starts monitoring voltage measurements taken by phase voltage and phase current measurement block 506 in the branch circuit electrical path (FIG. 5A).

If embedded processor 501 fails to detect a zero crossing in the phase voltage within 2 seconds, circuit breaker 500 remains in the detection mode and continues to monitor for a zero crossing in 2 second intervals (Block 804, State 902).

When a zero crossing is detected within a two minute interval, then the voltage detected by phase voltage and phase current measurement block 506 is measured by circuit breaker control task module 650 (State 903). If, at Block 805, the measured service voltage is less than nominal, then a brown-out condition exists (State 905). Embedded processor 501 continues to monitor the service voltage (Block 806). Any brown-out protections, such as opening latching relay 505, are initiated (Block 807), and procedure 800 returns to Block 803 to wait for the next zero crossing.

If, at Block 808, the measured service voltage is greater than nominal, then an overvoltage condition exists (State 906). Embedded processor 501 continues to monitor the service voltage (Block 809), any overvoltage protections, such as opening latching relay 505, are initiated (Block 810), and procedure 800 returns to Block 803 to wait for the next zero crossing.

On the other hand, if the service voltage is nominal, then embedded processor 501 waits for the service voltage to stabilize (Block 811, State 904). If the service voltage has not stabilized at Block 812, procedure 800 returns to Block 803 to wait for the next zero crossing. Otherwise, embedded processor 516 initiates normal system processing at Block 813 (State 907) and Procedure 800 returns to Block 803 and continues to monitor the service voltage.

Circuit breaker 500 also embodies a “soft-start” feature, which is invoked when the continuous monitoring provided by Procedure 800 detects a complete loss of service power or a brown-out condition detected when the service voltage decays below the level indicated in Table 7. Under either condition, embedded processor 501 opens latching relay 505 (e.g., latching relay 505 is “released”). When service power is restored, latching relay 505 remains open and the branch circuit is not immediately energized. Only after Procedure 800 executes and the service voltage for the phase connected to circuit breaker 500 is shown to be stable is latching relay 505 closed and the branch circuit energized. In multiple breaker systems, such as system 100 shown in FIG. 1A, an additional random delay is also added to each circuit breaker 500, which ensures that not all loads on the various branches in the building are energized at the same time.

In general, latching relay 505, under software control, provides a way to enable or disable power flowing through circuit breaker 500 under various conditions and in response to various inputs. Although a single input can open latching relay 505, and disable current flow to the branch circuit, unanimous commands from multiple inputs are preferably required, as discussed above. In the illustrated embodiment, embedded processor 501 can break the service power using latching relay 505 in response to a remote command from the electric power utility, a remote command from an authority taking emergency control, remote control command by a homeowner, and a brown-out condition detected by Procedure 800. To re-enable circuit breaker 500 by closing latching relay 505, the votes from the electric utility, the emergency control authority, and the home owner must all be positive and Procedure 800 must confirm that the service voltage is stable.

In the illustrated embodiment of circuit breaker 500, trip events are handled by multiple state machines, each running in its own task space. During typical operations, each state machine is initialized and then waits for events that cause transitions from state-to-state. The trip control state machines include a trip profile state machine, which responds to the enable, amperage, and response time states. A remote trip state machine responds to external commands. The remaining state machines control GFCI events and self-test, user push-button (forced GFCI) events and AFCI events.

The trip profile state machine determines how embedded processor 501 will interpret current measurements received from phase voltage and phase current measurement block 506 and phase current conditioning block 508 of FIG. 5A, as received through analog measurements and energy calculation block 607 of FIG. 6B.

In the trip profile, the trip amperage can be set from 1 amp nominal up to the maximum rating of thermal-mechanical circuit breaker mechanism 502 (FIG. 5A). The trip response time is nominally between 0.1 seconds and 10 seconds. If the amperage through the branch circuit is greater than the specified trip amperage parameter for the duration of the response time set in the trip profile, embedded processor 501 energizes trip solenoid 502, which trips thermal-mechanical circuit breaker mechanism 502. The event is also logged, and status LEDs 518 are set. Upon circuit breaker reset, the event is logged, and the status LEDs are cleared. The trip control state machine is active for both stand-alone and remote modes.

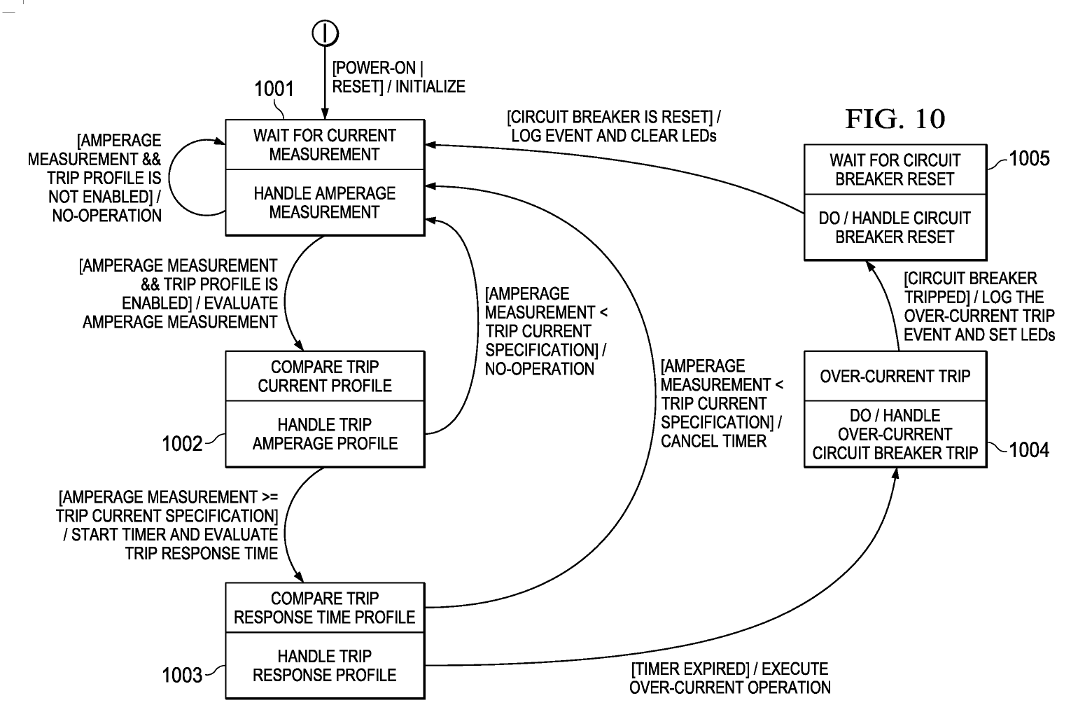

FIG. 10 is a state diagram illustrating a preferred trip control state machine 1000 responsive to a predetermined trip profile. The read/write parameters controlling state machine 1000 include: (1) trip profile enabled or disabled; (2) trip amperage; and (3) trip response time.

The input events to which state machine 1000 responds include: (1) power-on or reset; (2) amperage measurement; (3) trip timer expired; (4) thermal-magnetic circuit breaker mechanism 502 tripped; and (5) thermal-magnetic circuit breaker mechanism 502 reset.

Actions taken by trip control state machine 1000 include: (1) initializing trip control operations; (2) handling amperage measurements; (3) handling the trip amperage profile; (4) handling the trip response profile; (5) handling overcurrent circuit breaker tripping; (6) evaluating amperage measurements; (7) starting the trip timer and evaluating tripping response time; (8) executing overcurrent protection operations; (9) logging overcurrent trip events and setting LEDs 518; and (10) logging circuit breaker reset events and clearing LEDs 518.

The outputs provided by trip control state machine 1000 include the trip state of thermal-mechanical circuit breaker mechanism 502 (i.e., tripped or not tripped). In the illustrated embodiment, the trip state of thermal-mechanical circuit breaker mechanism 502 is indicated by LED flags display 518 (FIG. 5A), and in the remote mode, is available for transmission to a remote terminal, such as electrical supervision hub and gateway 200 (FIG. 1A).

More specifically, in State 1001 of FIG. 10, if the amperage measurement and trip profile options are enabled, state machine 1000 waits for current measurements to start after either power-on or reset of circuit breaker 500 and system initialization. (If either or both of the amperage measurement and trip profile options are disabled, then state machine 1000 remains in a “no-operation” state).

In enabled state, in State 1002, embedded processor 501 receives branch circuit amperage measurements from phase voltage and phase current measurement block 506 and phase current conditioning block 507 (FIG. 5A) and compares the measured amperage against the specified trip current amperage maximum defined in the trip profile. If the measured amperage is below the specified maximum amperage, then no action is taken and state machine 1000 returns to State 1001 and waits for the next periodic amperage measurement.

Otherwise, if the measured amperage for the branch circuit is at or above the maximum specified amperage defined in the trip profile, then embedded processor 501 sets a trip timer to the trip response time defined in the trip response profile. While the trip timer is active (i.e., the timer has not timed-out) at State 1003, state machine 1000 continues to measure the branch circuit amperage and compare the measured amperage against the maximum specified amperage from the trip profile. If the measured amperage falls below the specified maximum amperage, then the timer is cancelled and state machine 1000 returns to State 1001 for the next period branch circuit amperage measurement.

On the other hand, if the measured branch circuit amperage remains above the maximum specified amperage when the timer times-out, then embedded processor 501 executes overcurrent protection operations. In particular, at State 1004, embedded processor 501 activates trip solenoid 503 through trip circuit of latching relay and trip circuit block 504 (FIG. 5A), which trips thermal-mechanical circuit breaker mechanism 502. Embedded processor 501 also logs the event and sets one or more LEDs of LED flags display 518.

At State 1005, circuit breaker 500 remains in the tripped state, with current flow through the corresponding branch circuit disrupted, until reset. Circuit breaker 500 may be manually reset using reset button 522 in the stand alone mode, or by either a manual reset or command from an external device via optical interface 517, such as electrical supervision hub and gateway 200 (FIG. 1A), in the remote mode.

Once circuit breaker 500 is reset and current again flows through thermal-mechanical circuit breaker mechanism 502, state machine 1000 returns to State 1001 and waits for the next periodic branch circuit amperage measurement.

FIG. 11 is a state diagram for a preferred remote reset state machine 1100 for resetting circuit breaker 500 after a trip. Generally, remote trip state machine 1100 operates in its own task space and its behavior is defined by events related to remote tripping and circuit breaker reset. More particularly, state machine 1100 responds to events including: (1) power-on/reset; (2) remote trip commands; and (3) circuit breaker reset.

Actions taken by state machine 1100 include: (1) handling remote trip commands; (2) handling circuit breaker resets; (3) logging remote trip events and setting LEDs 518 for remote trips; and (4) logging circuit breaker resets and clearing LEDs 518. State machine 1100 provides circuit breaker remote trip state information (i.e., remote tripped or not remote tripped), through LED flags display 518 (FIG. 5A) or transmission to a remote terminal, such as electrical supervision hub and gateway 200 (FIG. 1A), via optical interface 517.

As shown in FIG. 11, following power-on or reset of circuit breaker 500, state machine 1100 waits at State 1101 for a remote trip command via optical port 517 (FIG. 5A). If a remote trip command is received, embedded processor 501 activates trip solenoid 503 through the trip circuit of latching relay and trip circuit block 504 (FIG. 5A), which trips thermal-mechanical circuit breaker mechanism 502. Embedded processor 501 logs the event and sets LED flags 518 to indicate a remote trip.

After a remote trip, state machine 1100 remains in State 1102, waiting for a circuit breaker reset, either manually using reset button 522 or remotely from command from an external device, such as electrical supervision hub and gateway 200 (FIG. 1A), when enabled. On reset, embedded processor 501 logs the reset event and clears the corresponding LEDs. State machine 1100 then returns to State 1100 and waits for the next remote reset command.

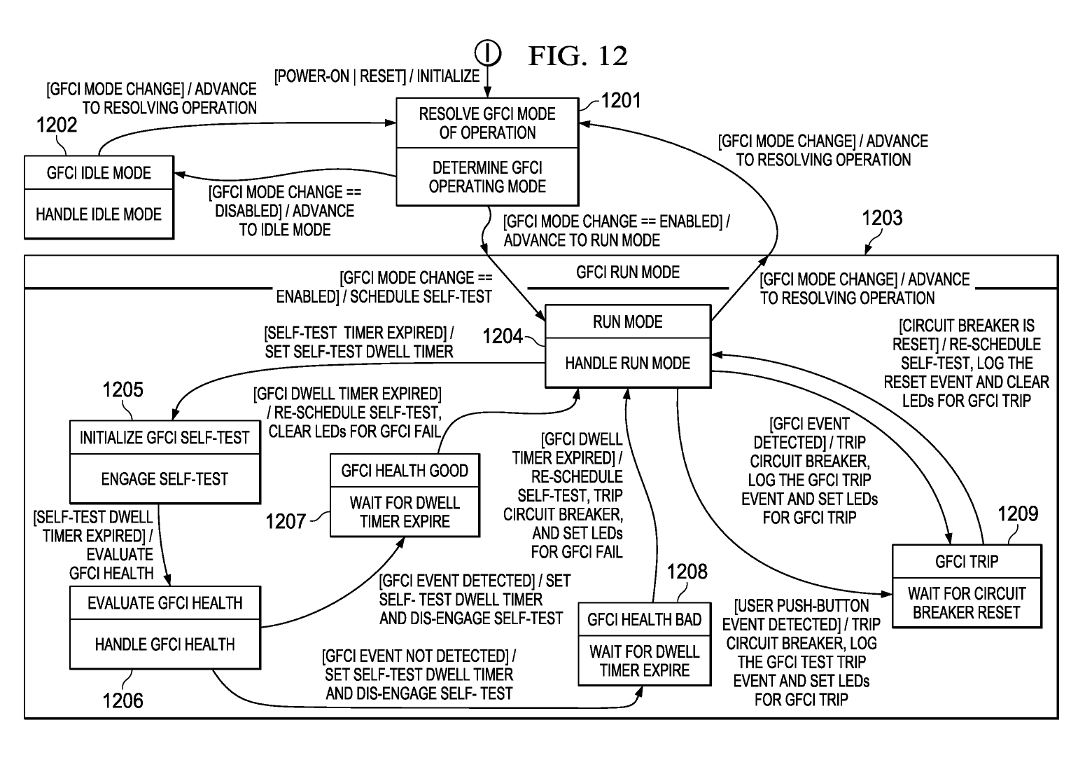

FIG. 12 is a state diagram illustrating a preferred GFCI control and self-test state machine 1200. GFCI control and test state machine 1200, which is optionally enabled, preferably operates in its own task space and determines, in software, how GFCI hardware signals received from GFCI sensor 509 and GFCI detect and self-test circuit block 510 (FIG. 5A) are evaluated.

GFCI self-test is preferably run on a schedule (e.g., every 5 minutes) to evaluate the health of the GFCI hardware and software. In the illustrated embodiment, GFCI self-test is implemented by applying an imbalance in the GFCI detection path using GFCI detect and self-test circuit block 510. An imbalance in the GFCI path under most circumstances will appear to embedded processor 501 as a GFCI event. If the GFCI function is found to be faulty, embedded processor 501 trips thermal-magnetic circuit breaker mechanism 502 using trip solenoid 503, logs the condition, and sets the appropriate LED flags 518 to indicate a GFCI failure. Circuit breaker 500 can then be manually reset, at which point GFCI operations restart, the reset event is logged, and the LEDs are cleared. If there is a hard-fail of the GFCI hardware and/or software, circuit breaker 500 continues to trip.

Normal GFCI run-time operation occurs when self-test is not engaged. During normal GFCI run-time operations, software waits for a GFCI event detected by GFCI sensor 509. If a GFCI event occurs, thermal-magnetic circuit breaker mechanism 502 is tripped with solenoid 503, and the GFCI trip event is logged. Circuit breaker 500 can then be manually, reset at which point GFCI operations restart, the reset event is log, and the LEDs are cleared. If there is a hard-fail of the GFCI hardware and/or software, circuit breaker 500 continues to trip. In addition, user push-button 521 (FIG. 5A) can be pressed, which forces a GFCI trip of thermal-magnetic circuit breaker mechanism 502, along with the appropriate event logging and setting of LEDs.

In the preferred embodiment of GFCI control and test state machine 1200, the controlling read/write parameters are the GFCI enable/disable command. The events triggering GFCI control and test state machine 1200 include: (1) power-on or reset; (2) GFCI mode change (idle/run); (3) self-test timer expiration; (4) dwell timer expiration; (5) GFCI event detection; (6) user push-button event detection; and (7) circuit breaker reset.

Actions take by GFCI control and test state machine 1200 include: (1) determining the GFCI operating mode; (2) handling the idle mode; (3) handling the run mode; (4) scheduling GFCI self-tests; (5) engaging GFCI self-test; (6) disengaging GFCI self-test; (7) setting the GFCI self-test dwell timer; (8) evaluating GFCI health; (9) rescheduling GFCI self-tests; (10) setting LEDs to GFCI trip; (11) setting LEDs to GFCI fail; (12) clearing LEDs of GFCI trip; (13) clearing LEDs of GFCI fail; (14) tripping thermal-magnetic circuit breaker mechanism 502 using trip solenoid 502; (15) logging circuit breaker GFCI trip events; (16) logging circuit breaker reset events; (17) handling GFCI health evaluation; (18) waiting for the dwell timer to expire; and (19) waiting for circuit breaker reset.

GFCI control and test state machine 1200, in the illustrated embodiment, provides status information including GFCI trip (true/false) and GFCI health (good/bad) status indicators.

At state 1201 of FIG. 12, after power-on or reset of circuit breaker 500, GFCI control and test state machine 1200 determines the GFCI operating mode. In particular, if GFCI disabled, then GFCI control and test state machine 1200 remains in the GFCI idle mode (State 1202). Any request to change to the GFCI run State returns the process back to State 1201 for resolving the GFCI mode of operation, which in turn returns the process back to the GFCI idle mode of State 1202, so long as GFCI remains disabled.

When the GFCI mode change feature is enabled, GFCI control and test state machine 1200 advances from GFCI mode of operation resolution State 1201 to the GFCI run mode operations shown collectively as State 1203. In the run mode, GFCI self-test is scheduled and GFCI control and test state machine 1200 advances to run mode State 1204.

If the self-test timer has expired, then self-test dwell timer is set and the process advances to State 1205, where GFCI self-testing is initialized and engaged. Once the self-test dwell timer has expired, then the GFCI detection path current is unbalanced and the GFCI health is evaluated at State 1206.

Specifically, if unbalancing the current through the GFCI path results in the detection of a GFCI event, then the self-test dwell timer is set and self-test is disengaged. The GFCI processing path is in good health and GFCI control and test state machine 1200 advances to State 1207 and waits for the self-test dwell timer to expire. When the self-test dwell timer expires, self-testing is rescheduled and LEDs 518 are cleared of an indication of a GFCI failure. GFCI control and test state machine 1200 then returns to run mode State 1204.

On the other hand, while in evaluation State 1206, if a GFCI event is not detected, then the self-test dwell timer is set and self-test is disengaged and GFCI control and test state machine 1200 advances to State 1208 and waits for the self-test dwell timer to expire. In this case, the GFCI processing path is considered in bad health. Once the self-test dwell timer expires, self-test is rescheduled, thermal-magnetic circuit breaker mechanism 502 is tripped using trip solenoid 502, and LED flags 518 are set to indicate a GFCI fail. GFCI control and test state machine 1200 returns to run mode State 1204.

During normal operations of circuit breaker 500 (i.e., outside of GFCI self-testing), GFCI control and test state machine 1200 advances from run mode State 1204 under at least two different scenarios, namely, a user activation of push button 521 or an GFCI event detected by GFCI sensor 509 (FIG. 5A). In each case, thermal-magnetic circuit breaker mechanism 502 is tripped using trip solenoid 502, the GFCI trip event is logged, and LED flags 518 are set to indicate a GFCI fail. GFCI control and test state machine 1200 advances to 1209 and waits for a circuit breaker reset.

After circuit breaker 500 is reset, self-testing is rescheduled, the reset event is cleared, and LED flags 518 are cleared. GFCI control and test state machine 1200 returns to run mode State 1204. In run mode State 1204, GFCI control and test state machine 1200 continues to advance through the GFCI monitoring and tripping operations and self-test operations continue to be executed each time the self-test timer expires, unless a GFCI mode change is requested. If a GFCI mode change is requested, GFCI control and test state machine 1200 returns to resolve GFCI mode of operation State 1201.

The preferred embodiment of circuit breaker also includes arc fault circuit interrupt (AFCI) capability. Embedded processor 501 detects the profiles of arc faults in the voltage and current waveforms measured by phase voltage and phase current measurement circuitry 506. Current waveform information can also be derived from the coils of GFCI sensor 509. (Generally, arc faults can be detected by observing the broadband noise frequency characteristics of the voltage and current waveforms, rapid changes in current (e.g., current spikes) during voltage half-wave cycles, and random, but locally persistent, patterns in the voltage and current waveforms).

When optionally enabled, the detection of AFCI events is handled similar to the detection of GFCI events. On detection of an arc fault, embedded processor 500 activates trip solenoid 503 through the trip circuit of latching relay and trip circuit block 504 (FIG. 5A), which trips thermal-mechanical circuit breaker mechanism 502. The AFCI trip event is logged and LED flags 518 are set to indicate an AFCI trip. Upon circuit breaker reset (manual or remote), the reset event is logged, and the LED flags 518 are cleared.

In addition to the circuit protection functions, circuit breaker 500 also implements metering functions for the associated branch circuit. To implement the metering functions, embedded processor 501 must accurately compute the active energy, reactive energy, active power, reactive power, apparent power, RMS voltage, and RMS current. The basic theory behind these computations is as follows.

The active energy, which is measured in the unit of watt hours (Wh), represents the electrical energy produced, flowing or supplied by an electric circuit during a time interval. The active energy in a typical one-phase power system is computed as an infinite integral of the unbiased instantaneous phase voltage u(t) and phase current i(t) waveforms:

Wh=∫₀^{∞}u(t)l(t)dt

The reactive energy is given by the integral, with respect to time, of the product of voltage and current and the sine of the phase angle between them. The reactive energy is measured in the unit of volt-ampere-reactive hours (VARh) and, in a typical one-phase power system, is computed as an infinite integral of the unbiased instantaneous shifted phase voltage u(t−90°) and phase current i(t) waveforms.

VARh=∫₀^{∞}u(t−90°)l(t)dt

The active power (P) is measured in watts (W) and is expressed as the product of the voltage and the in-phase component of the alternating current. The average power of any whole number of cycles is the same as the average power value of just one cycle, such that the average power of a very long-duration periodic waveform can be calculated simply by calculating the average value of one complete cycle with period T:

$$P = \frac{1}{T} {\int }_{0}^{∞} u ( t ) i ( t ) d t$$

The reactive power (Q) is measured in units of volt-amperes-reactive (VAR) and is the product of the voltage and current and the sine of the phase angle between them. The reactive power is calculated in the same manner as active power, but in reactive power the voltage input waveform is 90 degrees shifted with respect to the current input waveform:

$$Q = \frac{1}{T} {\int }_{0}^{∞} u ( t - 90 ° ) i ( t ) d t$$

The root Mean Square (RMS) is a fundamental measurement of the magnitude of an alternating signal. The basic equations for straightforward computation of the RMS current and RMS voltage from the signal function are the following:

$$IRMS = \sqrt{\frac{1}{T} {\int }_{0}^{T} {[ i ( t ) ]}^{2} d t}$$

$$URMS = \sqrt{\frac{1}{T} {\int }_{0}^{T} {[ u ( t ) ]}^{2} d t}$$

The total power in an AC circuit, both absorbed and dissipated, is the total apparent power (S), which is measured in the units of volt-amperes (VA). For any general waveforms with higher harmonics, the apparent power is given by the product of the RMS phase current and RMS phase voltage:

S=IRMS×URMS

For sinusoidal waveforms with no higher harmonics, the apparent power can also be calculated using the power triangle method, as a vector sum of the active power (P) and reactive power (Q) components:

S=\sqrt{P²+Q²}

Due to better accuracy, in the preferred embodiment, embedded processor 501 calculates the apparent power using the equation for any general waveforms with higher harmonics. In purely sinusoidal systems with no higher harmonics, both equations provide the same results.

The power factor of an AC electrical power system is defined as the ratio of the active power (P) flowing to the load to the apparent power (S) in the circuit and is a dimensionless number between −1 and 1:

$$COS ( ϕ ) = \frac{P}{S}$$

where:
the angle φ is the phase angle between the current and voltage waveforms in the sinusoidal system.

Circuits containing purely resistive heating elements (filament lamps, cooking stoves, and so forth) have a power factor of one. Circuits containing inductive or capacitive elements (electric motors, solenoid valves, lamp ballasts, and others) often have a power factor below one.

The one-phase embodiment of circuit breaker 500 implements the power measurement functions using filter-based metering algorithm library 608 of FIG. 6B. A filter-based algorithm accurately calculates active energy, reactive energy, active power, reactive power, apparent power, RMS voltage, and RMS current. Furthermore, a digital filter algorithm requires only instantaneous voltage and current samples be provided at constant sampling intervals.

In the illustrated embodiment of circuit breaker 500, which is based on a Freescale KM processor, the metering engine invokes various onboard peripherals including the phase-locked loop (PLL), the analog front end (AFE), which includes sigma-delta ADCs SD_ADC0 and SD_ADC2, the voltage reference (Vref), timer 2 (TMR2), the peripheral crossbar (XBAR), and the high-speed comparator 1 (CMP1).

Phase voltage and current values from phase voltage and phase current measurement block 506 are converted into digital samples in the AFE and accumulated in a data structure (block) for a fixed duration (e.g., 1 second). Metering is then triggered either by sample count, using the PLL, or when one second has elapsed, using the real time clock (RTC). Offsets are removed from the samples before blocks are updated. Generally, the sums updated during sampling include the RMS voltage, the RMS neutral current, active neutral power, and reactive neutral power.

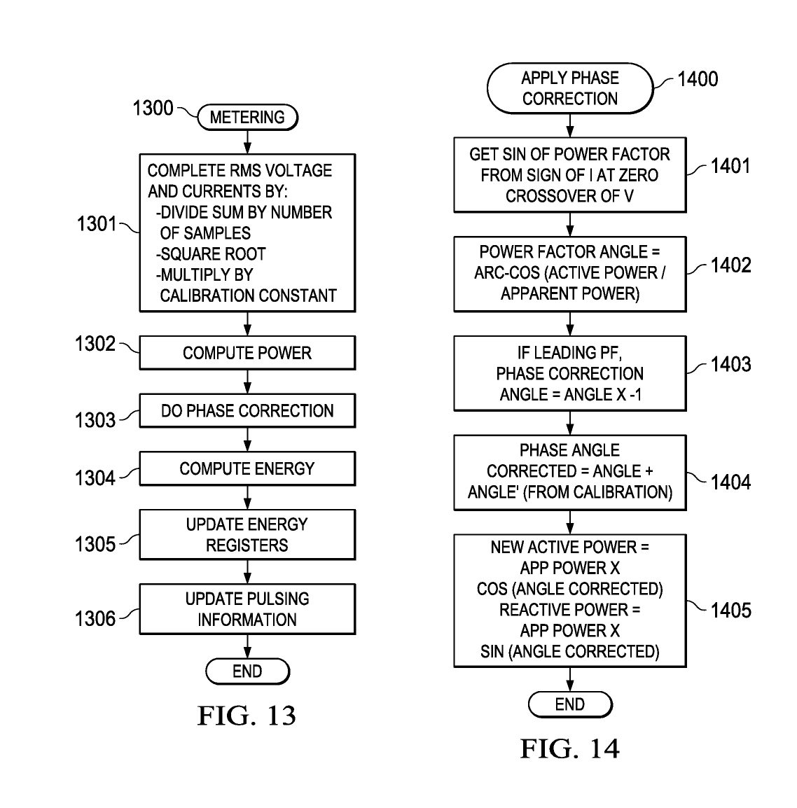

FIG. 13 shows a preferred overall metering procedure 1300 executed by data processing to module 645 and energy calculations module 646 of FIG. 6A. Generally, every one second the metering processing engine is triggered, and the raw voltage and current samples are converted into metering parameters.

Initially, the gathered sums are scaled and converted into 64-bits floating point form. Calibration constants are also applied. At Block 1301, the RMS voltage and RMS current values are calculated for the current block of samples. One way of calculating the RMS voltage or RMS current is to: (1) divide the sum of the samples in the block of voltage/current samples by the number of samples in the block; (2) take the square root of the result; and (3) multiply the new result by a calibration constant.

At Block 1302, the active neutral power, reactive neutral power, and apparent neutral power, along with the total neutral power, are computed. From these calculations, the power factor is also derived.

Phase correction is applied at Block 1303, preferably using Procedure 1400, discussed below in conjunction with FIG. 14. The powers calculated at Block 1302 are converted into energies at Block 1304. (Energy is recorded only in the import mode and is always forwarded.)

The energy registers are updated at Block 1305 and the energy data accumulated for the current metering period (block of data samples) is used to update the pulsing information driving the calibration LED of calibration block 519 (FIG. 5A). Auto-Calibration is invoked, if enabled, at Block 1306.

FIG. 14 is a flow chart illustrating a preferred phase correction Procedure 1400 suitable for use in Block 1303 of Procedure 1300. At Block 1401, the sign of the power factor is taken as the sign of the current at the zero crossover of the voltage. The power factor angle is then calculated at Block 1402 as:

Power Factor Angle=Arccos(active power/apparent power).

If the power factor is leading, the phase correction angle is determined at Block 1403:

Phase Correction Angle=Power Factor Angle−1.

At Block 1404, the corrected phase angle is:

Phase Angle Corrected=Phase Corrected Angle+Phase Calibration Phase Angle

The new active power and new reactive power are the calculated at Block 1405 as:

New Active Power=Apparent Power−cos(Phase Angle Corrected)

New Reactive Power=Apparent Power−sin(Phase Angle Corrected)

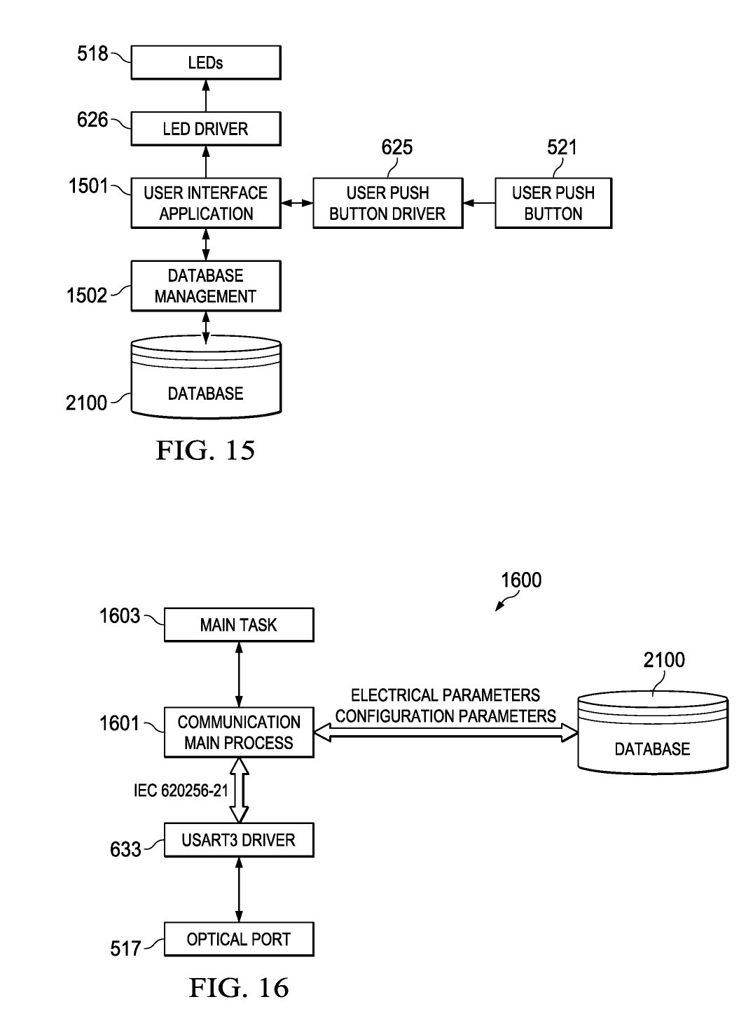

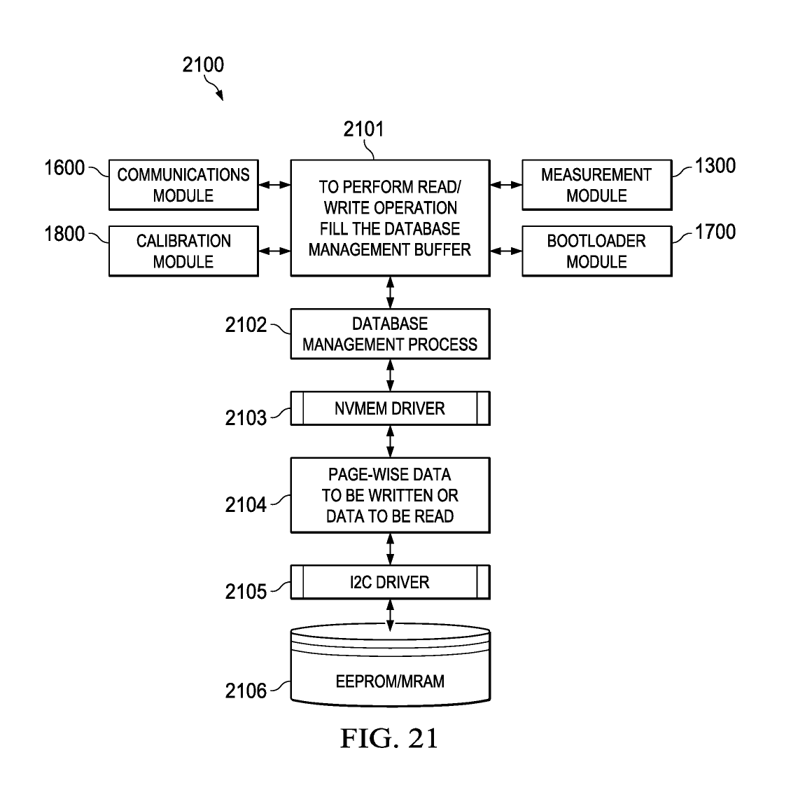

FIG. 15 is a block diagram illustrating the preferred user interface for circuit breaker 500. The user interface includes LED flags 518 and user push button 521 of FIG. 5 and a user push button driver LED drivers within bare-metal GPIO and port drivers block 626 of FIG. 6A. The user push button LED drivers communicate through user interface application software 1501 with database management software 1502 and database 2100, discussed further below in conjunction with FIG. 21.

As discussed above, user push-button 521 is used to test the GFCI circuitry, when enabled, and LED flags 518 indicate the status of circuit breaker 500 and the reason for a tripped condition. In one implementation, LED flags 518 include one LED that can display both red and green. By alternating between red and green, the human eye will interpret the LED color as yellow. In addition, an LED can be set to either a blinking or steady state.

Table 8 of the Appendix shows one preferred interpretation of the aspects of the LED flags 518 as the status of circuit breaker 500.

As previously discussed, circuit breaker 500 includes optical port 517 for establishing serial communications with external devices, such as electrical supervision hub and gateway 200 if FIG. 2. In the preferred embodiment, the Freescale FreeMASTER application software establishes a data exchange with a gateway application through the optical link. Preferably, the IEC 620256-21 Mode C protocol is used for data exchange.

FIG. 16 is a block diagram illustrating the communications process 1600 through optical port 517. Electrical and configuration parameters are exchanged between optical port 517, through UART3 driver 633 (FIG. 6A), and database 2100 (FIG. 21) under the control of communications main software process 1601 executed by communications task mode 648 (FIG. 6A). Communications main software process 1601 also provides the interface with main software task 1603.

Communications through optical port 517 are fully interrupt driven by UART3 Rx/Tx interrupts, which generate interrupt service calls with priority Level 2. Circuit breaker 500 acts as a slave device answering packets received from the master device (e.g., the gateway application running on electrical supervision hub and gateway 200). A recorder function is called by the calculation task every 833.3 μS. The Level 2 interrupt priority setting guarantees that data processing and calculation tasks (executed by data processing mode 645 and energy calculations module 646) are not impacted by the communication tasks. Reception of additional packets is disabled until the received (current) packet is processed.

The preferred implementation of the communications process uses the last 1024-byte sector of the internal Flash memory of embedded processor 501 for parameter storage (621 Block, FIG. 6B). By default, parameters are written after a successful calibration and read after a device reset. In addition, storing and reading parameters can be initiated through the FreeMASTER application.

In the illustrated embodiment, character transmission through optical communications port 517 are half duplex, asynchronous, with a baud rate 2400, 1 start bit, 7 data bits, 1 parity bit (even), 1 stop bit, and flow control=none. Data verification is implemented in the programming mode to ensure correct entry of data.

Optical port communications support different operating circuit breaker 500 operating modes. For example, in the data collection mode, data are collected from circuit breaker 500 for transmission to an external device, such as electrical supervision hub and gateway 200. The collected data may include, for example, header information (e.g., manufacturer's data, circuit breaker identity, unit serial number, software name, software version, software revision, and so.), electrical parameters (e.g., from metering or trip history) and configuration parameters.

The programming mode is used by an external device to configure circuit breaker 500 meter parameters and settings including: (1) reading the date, time, and current configuration parameters; (2) programming the serial number, the circuit breaker name, and circuit breaker number; (3) programming the service voltage, nominal voltage, the nominal current, and the nominal frequency; (4) programming the maximum demand integration period; (5) programming the optical link baud rate; (6) programming the pulse constant; and (7) clearing maximum demand parameters, tamper headers, and load profile headers.

In the calibration mode, the circuit breaker metering function is calibrated either manually or automatically.

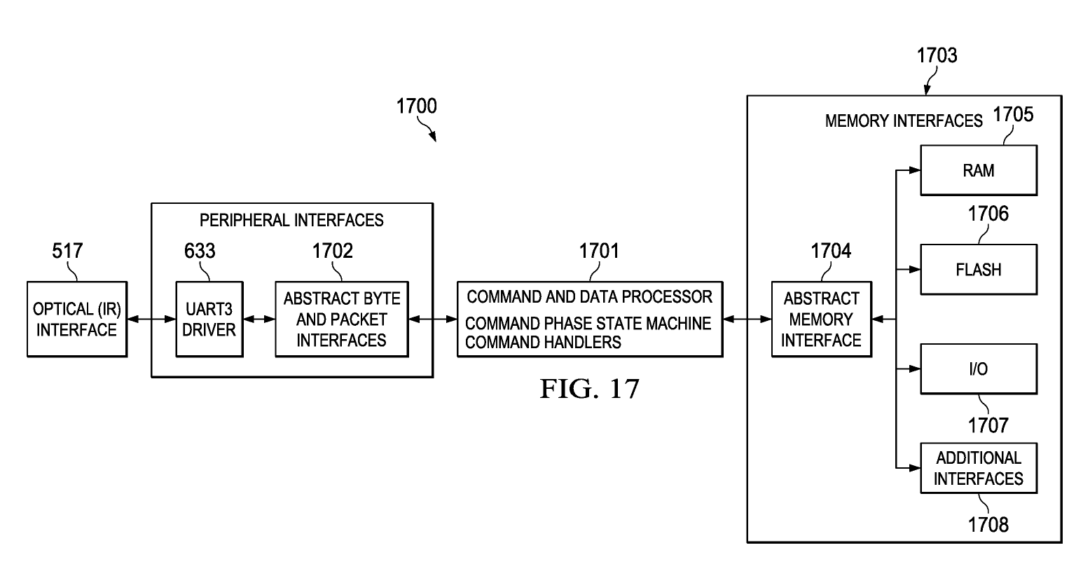

FIG. 17 is a block diagram of an exemplary bootloader 1700 implemented by embedded processor 501. In the illustrated embodiment of circuit breaker 500, bootloader 1700 is a Freescale Kinetis application that is programmed into the internal Flash memory of embedded processor 501 (Block 635, FIG. 6A). A UART manager synchronizes UART use between FreeMASTER communications and bootloader options.

Generally, bootloader 1700 is a small firmware program running in addition to the main “production” firmware program. Preferably, bootloader 1700 is installed at the factory and never changes, such that while bootloader 1700 facilitates the field update of the production firmware, it also helps guard against a firmware update failure that could render circuit breaker 500 unusable.

In the illustrated embodiment of circuit breaker 500, bootloader 1700: (1) prevents the firmware update process from being interrupted before it is finished, which would leaving circuit breaker 500 with incomplete updated firmware; (2) ensures that a corrupted update image is not uploaded to circuit breaker 500, thereby causing a failure; and (3) ensures that if a subtle bug introduced into the new firmware, even if the update itself not corrupted, the update can be replaced or reversed so that the original firmware may be re-installed.

Bootloader 1700 includes a command and data processor, command phase state machine, and command handlers, shown collectively as a set of processes within Block 1701. The processes of Block 1701 communicate with optical interface 517 through UART3 driver 633 and abstract byte and packet interfaces 1702.

The processes of Block 1701 also communicate with memory interfaces 1703 through an abstract memory interface 1704. In the illustrated embodiment, the individual memory interfaces include a RAM interface 1705, flash interface 1706, I/O interface 1707, and a set of one or more additional interfaces 1708.

Bootloader 1700 is configured to detect UART3 communications traffic through optical interface 517. Bootloader 1700 downloads a user application, writes that application to internal flash on embedded processor 501, and then resides along with the application in Flash memory 513.

In other words, flash-resident bootloader 1700 can be used to download and program an initial application image into a blank area in Flash memory 513, and to later update that application. Generally, the application image is downloaded to embedded processor 501 through a series of command and data packets sent from a remote source (e.g., electrical supervision hub and gateway 200, FIG. 1A), with bootloader 1700 running on embedded processor 501 as a communication slave.

The preferred embodiment of bootloader 1700 supports features including: (1) UART, I2C, SPI, and USB peripheral interfaces; (2) automatic detection of the active peripheral; (3) the ability to disable any peripheral; (4) UART autobaud; (5) common packet-based protocol for peripheral communications; (6) packet error detection and retransmission; (7) flash-resident configuration options; (8) flash security, including ability to mass erase or unlock security via a backdoor key; (9) protection of the RAM space used by bootloader 1700 while it is running; (10) commands for reading properties of circuit breaker 500, such as Flash and RAM size; and (11) multiple options for executing bootloader 1700 either at system start-up or under application control at runtime.

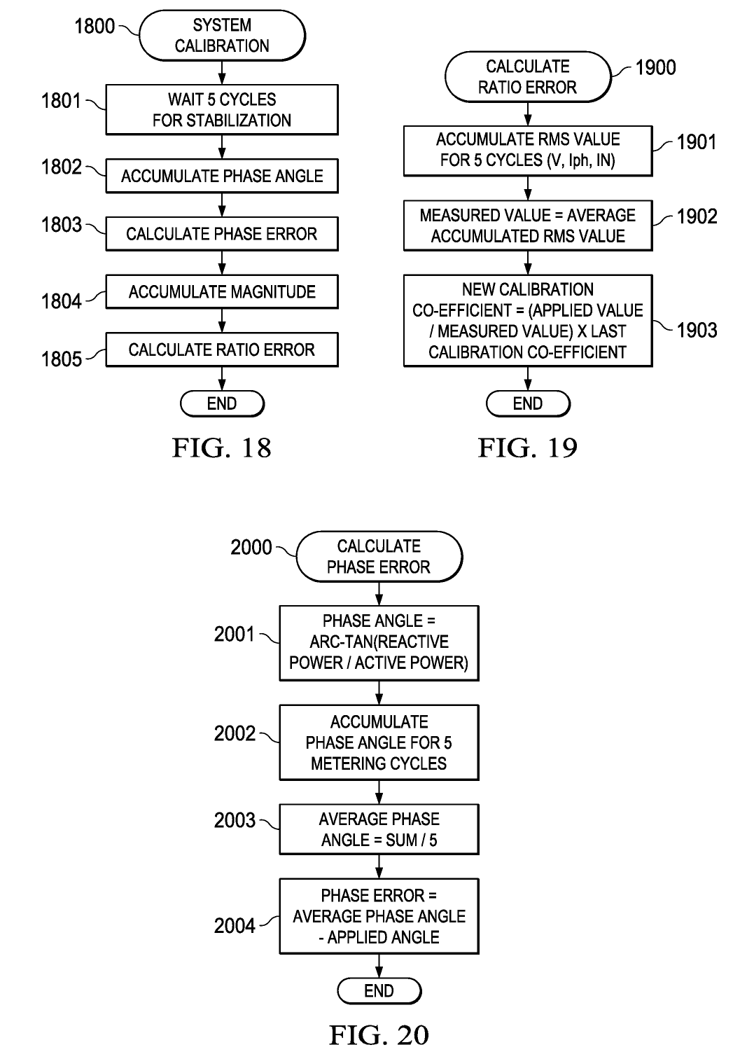

FIG. 18 is a flow chart of a preferred system calibration procedure 1800, which calibrates the metering functions to compensate for variations in the hardware measurement path (e.g., phase voltage and phase measurement circuitry 506, phase current conditioning circuitry 507, phase voltage conditioning circuitry 508, and the sigma-delta converters onboard embedded processor 501). Calibration can be initiated manually or automatically, using a single-point process.

Generally, during calibration, test equipment provides a known phase voltage (120 V or 240 V, depending on the configuration of circuit breaker 500) and a known phase current at unity power factor (i.e., the load point or LP) to phase voltage and phase current measurement circuitry 506. Software then calculates calibration coefficients, including calibration gains, offsets, and phase shifts, which are stored in nonvolatile memory.

In particular, at Block 1801 of system calibration procedure 1800, the calibration software running on embedded processor 501 waits for at least 5 AC cycles to allow for stabilization. Phase angle data are accumulated at Block 1802 for the phase voltage and phase current and the phase error is calculated at Block 1803. Similarly, phase voltage and phase current magnitude data are accumulated at Block 1804 and the ratio error is calculated at Block 1805.

A preferred ratio error calculation procedure 1900 is shown in FIG. 19. At Block 1901, samples of RMS phase voltage and phase current data are accumulated for at least 5 AC cycles. The measured phase voltage and current values are taken as the average of the phase voltage RMS values and the average of the RMS phase current values (Block 1902). The phase voltage and phase current calibration coefficients are then each calculated at Block 1903 as:

New calibration coefficient=(Applied value/measured value)−Last calibration coefficient value

A preferred procedure 2000 for calculating the phase error is shown in FIG. 20. At Block 2001, the phase angle is calculated for each AC cycle as:

Phase angle=arctan(reactive power/active power)

Phase angle values are accumulated for at least 5 AC cycles at Block 2002. The average phase angle is taken at Block 2003 by dividing the sum of the accumulated phase angle values by the number of cycles (e.g., 5). The phase error is finally calculated as the difference between the average phase angle and the applied phase angle (Block 2004).

Circuit breaker 500 maintains a database in EEPROM 514 (FIG. 5A), which includes structures for storing active, reactive, and apparent energy data, maximum demand (MD) data, calibration coefficients, configuration parameters, MD and cumulative energy values for the previous month, tamper headers and tamper data, and load profile headers and load profile data.

FIG. 21 is a block diagram of a preferred database 2100. Block 2101 represents read and write operations between a database management buffer and calculations module 646, communications module 648, bootloader module 617, and calibration module 643.

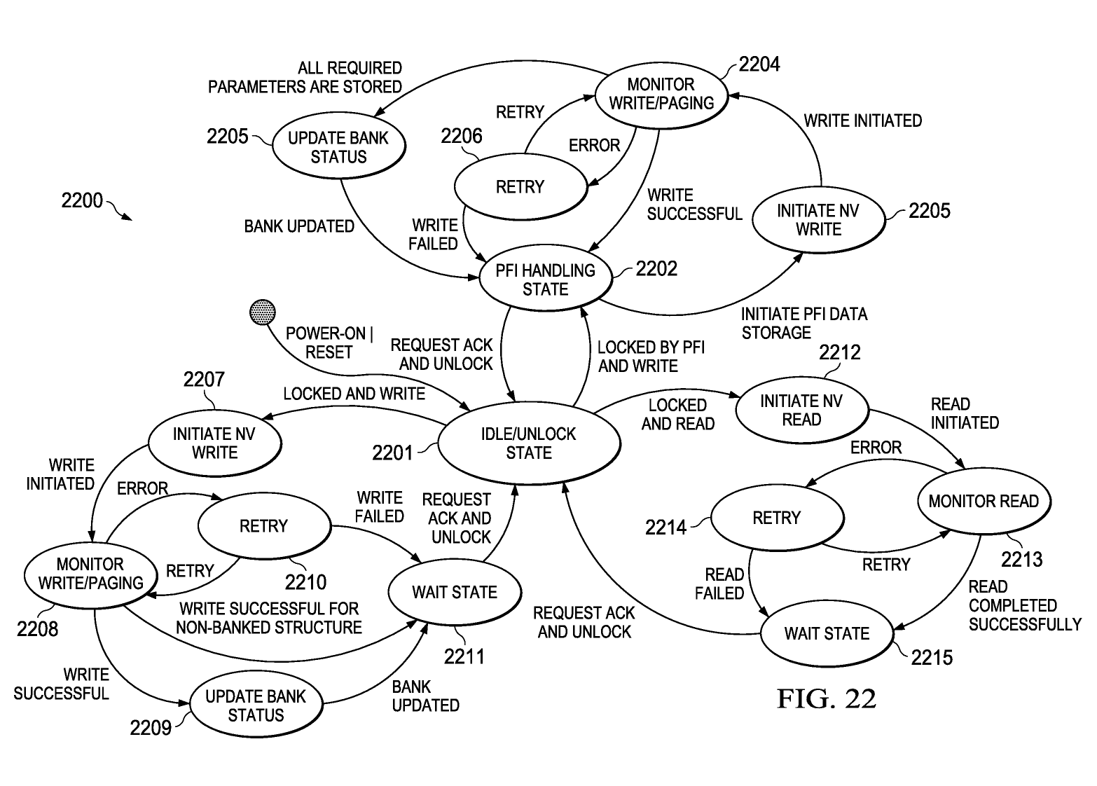

Table 9 illustrates a preferred set of nonvolatile memory events (operations), which also apply to the state diagram of FIG. 22, discussed below. Table 10 illustrates an allocation of the nonvolatile memory space (e.g., Flash 513, EEPROM 814, and non-volatile memory onboard embedded processor 501) for the storage of various types of data in the preferred embodiment.

Data reads and writes to the database management buffer are controlled with a database management process module 2102 operating in conjunction with nonvolatile memory drivers 617. In the illustrated embodiment of circuit breaker 500, data are written and read page-wise through I2C driver 618 to and from a memory block 2016 within EEPROM 514.

In the illustrated embodiment, data management process module 2102 controls read/write operations in response to a request from another software module, such as calculations module 646, communications module 648, bootloader module 635, or calibration module 643. (Any software module can initiate a read/write operation after obtaining the database lock.) Write/Read operations are preferably performed one structure at a time (e.g., by pages). Data management process module 2102 also handles post wait, bank update, and retry states for any read/write operation initiated by another software module.

Nonvolatile memory (NVMEM) driver 617 receives read/write requests from data management process module 2102, and based on the type of nonvolatile memory, executes the requested read/write operation. In the illustrated embodiment, where accesses are made to I2C EEPROM 514, I2C driver 618 executes the requested read/write operation and accesses are made in pages up to a maximum of 128 bytes.

The software module requiring access to EEPROM 517 first obtains a LOCK, which ensures that only one software module can access EEPROM 517 at a time. In the event a lock is unavailable, the requesting module either waits until the lock is released or terminates the request. Once the lock is obtained, I2C transmission and reception operations execute as interrupt-based operations. In the illustrated embodiment, the I2C baud rate is configured for 100 kHz exchanges with EEPROM 517.

In response to a successful read/write to EEPROM 517, data management process module 2102 returns a DB_SUCCESS message to the requesting module and the lock is released On a read/write failure to EEPROM 517, data management process module 2102 attempts a selected number of retries (in the illustrated embodiment 3 retries). If unsuccessful after the allowed number of retries, data management process module 2102 returns a DB_FAILURE message to the requesting module and releases the lock.

In the illustrated embodiment, active energy calculations and the status of various tampers are saved in RTC nonvolatile memory at a fixed interval of 1 minute. At the time of power-up, the latest energy from RTC RAM is copied into EEPROM 514. In addition, data management process module 2102 validates the signatures of the data bank. (The preferred embedded processor 501 uses banked an non-banked memory accesses. In a non-banked access, a memory location can be directly accessed by an address, whereas in a banked access, expanded addressing is required through the use of a register.) If either of the bank signatures is valid, the application reads the energy information, maximum demand parameters, load profile information, configuration parameters, calibration parameters, energy headers, and tamper headers from nonvolatile memory. If both the bank signatures are invalid, then defaults are written to non-volatile memory. CRC checks are performed for each structure to ensure data integrity.

Database management processor module 2101 implements a maximum demand register in nonvolatile memory. The maximum demand (kW) is calculated from the accumulated active energy data over a given maximum demand interval. Each recorded maximum demand calculation is time stamped, and the maximum demand and cumulated energy values for the prior six months are stored in EEPROM 514.

In the illustrated embodiment, the maximum demand calculation is performed using a fixed window method. In particular, the power through circuit breaker 500 is calculated from the measured RMS voltage and RMS current. The power is this integrated over a integration interval, which in the illustrated embodiment is programmable to be either 30 or 60 minutes. At the end of each integration period, the average power for that period is calculated. If this value is greater than the already existing maximum demand value stored in memory, then this average power value is stored as the new maximum demand value. The maximum demand in kWh is stored in nonvolatile memory along with the date and time.

All the maximum demand parameters are cleared from memory on maximum demand reset, which is implemented, for example, through optical serial communications port 517.

Circuit breaker 500 maintains load profile data in a circular buffer in non-volatile memory in accordance with a programmable load profile interval time. Table 11 illustrates an exemplary load profile stored in EEPROM 514. A typical set of load profile entries taken over 45 days is shown in Table 12 for representative load profile intervals.

Load profile records are read through optical serial communications port 517 by external systems, such as electrical supervision hub and gateway 200 (FIG. 1A) and an associated utility program. In the illustrated embodiment, a load profile will only be saved for the last 45 days on a first-in-first-out basis and the load profile for the day on which the metering function and/or circuit breaker 500 are powered-off is not recorded. Load profile records may also be cleared through optical serial communications port 517.

FIG. 22 is a state diagram of a set of operations 2200 between a software module and EEPROM 514. On power-on or reset, database management process module 2102 is in the idle/unlock state 2201. Database management process module 2102 returns to the idle/lock state 2201 when no reads or writes are being made to EEPROM 517.

In the event of a power fail interrupt (PFI) (e.g., last gasp), critical parameters are saved to EEPROM 517 before a complete power loss occurs. The PFI locks accesses to EEPROM 517 and database management process module 2102 transitions to PFI handling state 2202.

From PFI handling state 2202, database management process module 2102 initiates write of the critical parameters to memory through I2C driver 618 (state 2203). Database management process module 2102 monitors writes to memory in state 2204. If all parameters are successfully written to memory, then the bank status is updated in update bank status state 2205 and database management process module 2102 returns to PFI handling state 2202.

In the event of a write failure, database management process module 2102 will initiate a predetermined number of retries (state 2206). If the write continues to fail despite the maximum number of retries, then database management process module 2102 returns to the PFI handling state 2202.

During normal operations, when a module, such as calculations module 646, communications module 648, bootloader module 635, or calibration module 643 generates a memory access lock, database management process module 2102 transitions to initiate NV write state 2207 and initiates a write to EEPROM 517 through I2C driver 618, after which database management process module 2102 transitions to monitor write/paging state 2208.

On a successful write, for a non-banked data structure, database management process module 2102 transitions directly to wait state 2211. For a write of a banked data structure, database management process module 2102 updates the bank status in state 2209 and then transitions to wait state 2211 after the bank update. In the event of a write failure, database management process module 2102 will attempt a predetermined number of retries (state 2210), after which it transitions to wait state 2211.

In wait state 2211, database management process module 2102 signals to the module requesting the data write that the write operation is complete (either successful or unsuccessful) and requests release of the lock to EEPROM 517. On release of the lock, database management process module 2102 returns to the idle/unlock state 2201.

When a module locks EEPROM 517 for a read operation, database management process module 2102 initiates the read in state 2212 through I2C driver 618. Database management process module 2102 then monitors the read operation in state 2213.

On a successful read, database management process module 2102 transitions to wait state 2215, otherwise, database management process module 2102 attempts up to the maximum number of retries in state 2214. On a failed read after the maximum number of retry attempts, database management process module 2102 enters wait state 2215.

In wait state 2215, database management process module 2102 signals to the module requesting the data read that the read operation is complete (either successful or unsuccessful) and requests release of the lock to EEPROM 517. On release of the lock, database management process module 2102 returns to the idle/unlock state 2201.

Generally, manufacturers commonly use different mechanical layouts for both circuit breakers and circuit breaker panels, including those used in single-family, commercial, multi-tenant, and industrial settings, which reduces or eliminates interchangeability. Advantageously, the hardware and software architecture described above advantageously allows circuit breaker 500 to be packaged with different form factors, as required for circuit breaker 500 to be used in commercially available power distribution panels.

The embedded processor 501 and supporting electronics are preferably supported and interconnected by a four-layer or more printed circuit board (PCB), required to maintain the accuracy of the 24-bit SD ADC for measurement accuracy.

The preferred embodiment of circuit breaker 500 is evaluated for power meter immunity for: (1) electrostatic discharge (ESD) according to EN 61000-4-2; (2) magnetic field of the network with intensity 30 Nm according to EN 61000-4-8; (3) short-time supply voltage dips (DIPS) according to EN 61000-4-11; (4) short-time interruptions of supply voltage (INTERRUPT) according to EN 61000-4-11; (5) fast transients (BURST) according to EN EN61000-4-4; (6) voltage surge (SURGE) according to EN61000-4-5; and (7) injected currents according to EN61000-4-6.

Overall, circuit breaker 500 includes overload, AFCI, and GFCI capabilities, in contrast to most commercially available circuit breakers, which include only overload and AFCI protection or only overload and GFCI protection. Moreover, in circuit breaker 500, the AFCI and GFCI protections can be selectively enabled and disabled, depending on the needs of the particular application.

Circuit breaker 500 also has built-in branch testing and status monitoring capabilities. Among other things, the branch circuit is critically monitored for any anomalies that indicate that there may be a potential electrical problem. Power surges, excessive voltage drops, uncharacteristic load profiles are evaluated. The results of the test and monitoring is available through the remote communication infrared optical link.

Certificate based VPN secure communications are implemented in electrical supervision hub and gateway 200 for supporting cloud-based services over the public internet. Communication packets sent between cloud-based services and the gateway are preferably wrapped in a VPN tunnel, which eliminates the need for passwords for maintaining security.

Preferably, the user owns all sensor and device data with regards to circuit breaker 500 and electrical supervision hub and gateway 200. An extra level of encryption is provided, which is certificate-based using the credentials of the user. The user chooses how the data can be used and for what purpose; data can be entirely restricted from use, or made accessible individually to various third parties and purposes.

Circuit breaker 500 and electrical supervision hub and gateway 200 also support electric utility demand-response. The circuit breaker 500 associated with a given electrical branch circuit may be tagged with identification, type of use, and prioritization. Those branch circuits that represent the largest load to the grid may be prioritized as the best candidates to turn-off during a cutback in the demand for power. On the other hand, branch circuits that are related to medical operations are so marked and have the least likelihood of being turned off.

In addition to circuit breaker panels, circuit breaker 500 is also suitable for embedding within electrical appliances and stand alone electrical receptacles. In the preferred electrical appliance and electrical receptacle embodiments of circuit breaker 500, one or more of the remote communications modules of HAN interface 300 are embedded within circuit breaker 500 in addition to or in lieu of optical port 517. In other words, circuit breaker 500 supports remote communication with an external device or system through an optical link, WiFi, BlueTooth, Zigbee, ZWave, or EOP.

In the electrical appliance and electrical receptacle embodiments of circuit breaker 500, the remote communications capability supports the features discussed in detail on a circuit breaker by circuit breaker basis, including: (1) remote firmware upgrade; (2) the receipt of data from an external device or system for mitigating nuisance tripping; (3) remote enablement and disablement of arc and/or ground fault detection; (4) remote electrical parameter adjustment (e.g., trip amps and response time; (5) remote power control through branch circuit switch 505; (6) electrical sub-metering on an appliance by appliance and/or electrical receptacle by receptacle basis; (7) power line testing and status monitoring on an appliance by appliance and/or electrical receptacle by receptacle basis; and (8) remote programming of meta-data for electrical appliance and/or electrical receptacle identification, naming, prioritization, and so on.

As with the circuit breaker panel embodiment discussed above, the electrical appliance and electrical receptacle embodiments are configurable for operation at 120 or 240 volts, 50 or 60 Hz, and with 1, 2, or 3 phase electrical power. Preferably, the electrical appliance and electrical receptacle embodiments also include the soft start on restore of electrical power and the measurement and set-up memory caches for persisting data.

Embodiments of circuit breaker 500 having embedded remote communications capability advantageously support distributed equipment identification tags. Among other things, an embodiment of circuit breaker 500 with remote communications capability with support a network addressable electrical plug or receptacle that will identify equipment on the corresponding branch circuit. In addition, the remote communications capability will support electrical appliance and/or electrical receptacle identification, naming, and or/prioritization for restoring electrical grid, power system, or branch circuit operations.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore contemplated that the claims will cover any such modifications or embodiments that fall within the true scope of the invention.

### APPENDIX

TABLE 1
Input

| | | |
|---|---|---|
| Voltage | 85-500 | VAC |
| Frequency | 48-62 | Hz |

Output

| | | |
|---|---|---|
| Switching | 22.5 | kHz |
| Frequency | | |
| Power | 3.3 | W |

| | |
|---|---|
| Voltage 1 | 22 v ± 1 v |
| Voltage 2 | 3.3 V ± 1% |
| Current | 150 rnA output current on 22 V and 2 rnA on 3.3 V |
| | for full input voltage range |
| Standby | <75 mW/300 mVA at 240 VAC (2 rnA on 3.3 V and |
| Power(W/VA) | no load on 22 V) |
| Efficiency | >65% |
| Overload/Short- | Protected |
| circuit | |
| Output | Protected |
| overvoltage | |
| Isolation | Non-isolated - Neutral connected to output GND |
| EMI | In accordance with EN55022 - class B |
| EMC | Surge - IEC 61000-4-5 - 4 kV |
| EMC | EFT- IEC 61000-4-4- 4 kV |

TABLE 2
Coil

| Inductance | 1800 | uH |
|---|---|---|
| Roc | 2.8Q | |
| RMS Current | 330 | mA |
| Saturation Current | 600 | mA |

| | |
|---|---|
| Manufacturer | Wurth |
| Coil Type | 744732102 |

Coil Currents

| Selected mains voltage | 85 | VAc |
|---|---|---|
| Selected output power | 2.4 | w |
| Selected mains frequency | 50 | Hz |
| Peak coil current | 417 | mA |
| RMS coil current | 151 | rnA |
| Switching frequency | 22.5 | kHz |
| Mode of operation | DCM | |
| Duty cycle | 0.10 | |
| On-time | 4.28 | f./S |
| Off-time | 18.96 | f./S |
| Dead-time | 21.20 | f./S |

TABLE 3

| Specification | Description | |
|---|---|---|
| Type of meter | One-phase residential | |
| Type of measurement | 4-Quadrant | |
| Metering algorithm | Filter-based | |
| Precision (accuracy) | IEC50470-3 class C, 0.5% (for | |
| | active and reactive energy) | |
| Voltage range | 90 . . . 265 | VRMs |
| Current Range | 0 to 20 | A |
| Frequency range | 47 to 63 | Hz |
| Meter constant (imp/kWh, | 500, 1000, 2000, 5000, 10000, 20000, | |
| imp/kVARh) | 50000, 100000, 200000, 500000, | |
| | 1000000, 20000000, 40000000, and | |
| | 6000000. ¹ | |
| Functionality | V, A, kW, kVA, kWh, kVARh | |
| | (lead/lag), Hz, time, date | |
| Voltage sensor | Voltage divider | |
| Current sensor | Shunt resistor 500 μΩ | |
| Energy output pulse interface | Two red LEDs (active and reactive | |
| Energy output pulse parameters: | | |
| Maximum frequency | 600 | Hz |
| On-Time | 20 ms (50% duty cycle typical) | |
| Jitter | ±10 μs at constant power | |
| User interface | LED's, push-button | |
| Infrared interface | Optocoupler | |
| External NVMs | | |
| Flash | 512 | kB |
| EEPROM | 64 | kB |
| Power consumption @ 3.3 V | 10.88 | rnA |
| and 22° C. | | |

¹ Pulse numbers above 50000 are applicable only to low-current measurements.

TABLE 4

| Task | | Function | Trigger | Interrupt | |
|---|---|---|---|---|---|
| Name | Description | Name | Source | Priority | Calling Period |
| Power meter | Performs power | CONFIG_{—} | Device reset | — | After 1st device |
| calibration | meter | UpdateOffsets | | | reset, and a |
| | calibration and | CONFIG_{—} | | | special load point |
| | stores | CalcCalibData | | | is applied by the |
| | calibration | | | | test equipment |
| | parameters. | | | | |
| Operating | Operating mode | Main | Device reset | — | After every device |
| mode control | state transition | | | | reset |
| Circuit breaker | Handle circuit | cb_control | Evaluate CB | Level 3 | Periodic 250 ms |
| control | breaker state | | current, GFCI | (lowest) | |
| | control, trip | | status, AFCI, | | |
| | control, GFCI | | and control | | |
| | control, AFCI | | breaker | | |
| | control | | appropriately | | |
| Data | Reads digital | afech2 | AFE CH2 | Level 0 | Periodic 166.6 μs |
| processing | values from the | callback | conversion | (highest) | |
| | AFE and | | complete | | |
| | performs | | interrupt | | |
| | scaling. | | | | |
| Calculations | Calculation of | auxcal | AFE CH2 | Level 1 | Periodic 833.3 μs |
| | power quantities | callback | conversion | | |
| | | | complete | | |
| | | | interrupt | | |
| HMI | Updates LEDs | display_{—} | AFE CH2 | Level 3 | Periodic 250 ms |
| control | with new values | callback | conversion | (lowest) | |
| | and controls cb | | complete | | |
| | state after user | | interrupt | | |
| | button is | | | | |
| | pressed. | | | | |
| FreeMASTER | Application | FMSTR_Init | UART3 | Level 2 | Asynchronous |
| communication | monitoring and | | Rx/Tx | | |
| | control | | interrupts | | |
| FreeMASTER | Recorder | FMSTR_{—} | AFE CH2 | Level 1 | Periodic 833.3 μs |
| communication | | Recorder | conversion | | |
| | | | complete | | |
| | | | interrupt | | |
| Bootloader | Loads firmware | complex API | Remote | | |
| | into flash | | command | | |
| Parameter | Write/read | CONFIG | After | — | |
| management | parameters | SaveFlash | successful | | |
| | from flash | CONFIG | calibration or | | |
| | | ReadFlash | controlled by | | |
| | | | user | | |

TABLE 5

| Peripherals | Usage |
|---|---|
| TMRI | General purpose timeout timer |
| TMR2 | Zero crossing timing to compute frequency |
| AFEO | Phase Current |
| AFE2 | Phase Voltage |
| I2CI | EEPROM |
| SPIO | FLASH |
| SCI3 | Optical communication |
| XBAR | Connect CMPI to TMR2 |
| CMPI | Zero cross detection to detect voltage and compute |
| | frequency |
| LEDs | HMI presentation |
| VREF | Voltage reference for AFE |
| RTC | Real time management |
| NVIC | Interrupt controller for various interrupts |
| PLL | Bus and AFE clock source |

TABLE 6

| Interrupts | Priority Level |
|---|---|
| TMRI | 2 |
| TMR2 | 2 |
| AFEO | 3 |
| AFE2 | 3 |
| I2CI | 0 |
| SPIO | 2 |
| SCI3 | 2 |
| RTC | 3 |
| DMA | 2 |
| User push button | 3 |

TABLE 7

| Service Voltage | Brown-out | Over-voltage |
|---|---|---|
| 120 VAC | <105 VAC | >135 VAC |
| 240 VAC | <210 VAC | >270 VAC |

TABLE 8

| Circuit Breaker Status | Green | Red | Yellow | Blinking |
|---|---|---|---|---|
| No power | Off | Off | Off | n/a |
| Normal | On | Off | Off | Off |
| Over-current trip | Off | On | Off | Off |
| GFCI trip | Off | On | Ott | On |
| AFCI trip | Off | Off | On | On |

TABLE 9

| Events | Descriptions |
|---|---|
| Locked and | Event indicates any one of metering, init. database, |
| Write | communication, circuit breaker application, or user |
| | interface has locked the database module for writing |
| | data to non-volatile memory. |
| Locked and | Event indicates any one of metering, init. database, |
| Read | communication or user interface has locked the database |
| | module for reading data to nonvolatile memory. |
| Write | Event indicates to initiate writing corresponding data |
| Initiated | structure to nonvolatile memory. |
| Read | Event indicates to initiate reading of corresponding data |
| Initiated | structure from nonvolatile memory. |
| Error | Event indicates error happened during write/read operation |
| | and need to retry. |
| Retry | Event indicates the retry of the write/read operation has |
| | been started. |
| Write Failed | Event indicates write operation has been failed even after |
| | maximum number of retries. |
| Read Failed | Event indicates read operation has been failed even after |
| | maximum number of retries. |
| Write | Write operation of banked structure is successfully over and |
| Successful | bank status has to be updated. |
| Read | Read operation is successfully over release of database |
| Successful | module has to be done. |
| Write | Write operation of non-banked structure is successfully over |
| Successful | and release of database module has to be done. |
| for non- | |
| banked | |
| structure | |
| Bank | Bank status structure is updated for corresponding banked |
| Updated | structure and written into nonvolatile memory. |
| Request | Indicates respective module that write/read operation done |
| ACK | and request to release database module. |
| and Unlock | |

TABLE 10

| Structure | Bytes |
|---|---|
| Number of bytes required by Energy | 64 |
| Registers | |
| Number of bytes required by Maximum | 32 |
| demand | |
| Number of bytes required by Calibration | 64 |
| coefficients | |
| Number of bytes required by Configuration | 96 |
| parameters | |
| Number of bytes required by MD and | 10 |
| Energy | |
| Cumulative Header | |
| Number of bytes required by MD and | 192 |
| Energy | |
| Cumulative Data Part | |
| Number of bytes required by Load profile | 25938 |
| Total number in Bytes | 26,396 |
| Total number in Kbytes | 25.777 |

TABLE 11

| Day 1 (Date) | Day 2 (Date) | Day i | Day j | Day 45 (Date) |
|---|---|---|---|---|
| LP 00:00 to | LP 00:00 to | — | — | LP 00:00 to |
| 01:00 | 01:00 | | | 01:00 |
| LP 01:00 to | LP 01:00 to | — | — | LP 01:00 to |
| 02:00 | 02:00 | | | 02:00 |
| LP 02:00 to | LP 02:00 to | — | — | LP 02:00 to |
| 03:00 | 03:00 | | | 03:00 |
| LP 03:00 to | LP 03:00 to | — | — | LP 03:00 to |
| 04:00 | 04:00 | | | 04:00 |
| LP 04:00 to | LP 04:00 to | — | — | LP 04:00 to |
| 05:00 | 05:00 | | | 05:00 |
| LP 05:00 to | LP 05:00 to | — | — | LP 05:00 to |
| 06:00 | 06:00 | | | 06:00 |
| LP 06:00 to | LP 06:00 to | — | — | LP 06:00 to |
| 07:00 | 07:00 | | | 07:00 |
| LP 07:00 to | LP 07:00 to | — | — | LP 07:00 to |
| 08:00 | 08:00 | | | 08:00 |
| LP 08:00 to | LP 08:00 to | — | — | LP 08:00 to |
| 09:00 | 09:00 | | | 09:00 |
| LP 09:00 to | LP 09:00 to | — | — | LP 09:00 to |
| 10:00 | 10:00 | | | 10:00 |
| LP 10:00 to | LP 10:00 to | — | — | LP 10:00 to |
| 11:00 | 11:00 | | | 11:00 |
| LP 11:00 to | LP 11:00 to | — | — | LP 11:00 to |
| 12:00 | 12:00 | | | 12:00 |
| LP 12:00 to | LP 12:00 to | — | — | LP 12:00 to |
| 13:00 | 13:00 | | | 13:00 |
| LP 13:00 to | LP 13:00 to | — | — | LP 13:00 to |
| 14:00 | 14:00 | | | 14:00 |
| LP 14:00 to | LP 14:00 to | — | — | LP 14:00 to |
| 15:00 | 15:00 | | | 15:00 |
| LP 15:00 to | LP 15:00 to | — | — | LP 15:00 to |
| 16:00 | 16:00 | | | 16:00 |
| LP 16:00 to | LP 16:00 to | — | — | LP 16:00 to |
| 17:00 | 17:00 | | | 17:00 |
| LP 17:00 to | LP 17:00 to | — | — | LP 17:00 to |
| 18:00 | 18:00 | | | 18:00 |
| LP 18:00 to | LP 18:00 to | — | — | LP 18:00 to |
| 19:00 | 19:00 | | | 19:00 |
| LP 19:00 to | LP 19:00 to | — | — | LP 19:00 to |
| 20:00 | 20:00 | | | 20:00 |
| LP 20:00 to | LP 20:00 to | — | — | LP 20:00 to |
| 21:00 | 21:00 | | | 21:00 |
| LP 21:00 to | LP 21:00 to | — | — | LP 21:00 to |
| 22:00 | 22:00 | | | 22:00 |
| LP 22:00 to | LP 22:00 to | — | — | LP 22:00 to |
| 23:00 | 23:00 | | | 23:00 |
| LP 23:00 to | LP 23:00 to | — | — | LP 23:00 to |
| 00:00 | 00:00 | | | 00:00 |

TABLE 12

| Load Profile | Number of | Total Entries |
|---|---|---|
| Interval | Entries Per Day | for 45 Days |
| 15 minutes | 96 | 4320 |
| 30 minutes | 48 | 2160 |
| 60 minutes | 24 | 1080 |

What is claimed is:

1. A circuit breaker system integrated into a package including an input for coupling to an external electrical power source, an output for coupling to an external electrical circuit, and a current path selectively coupling the input and the output, comprising:
a mechanical circuit breaker mechanism for interrupting electrical power flowing through the current path in response to a current through the current path exceeding a predetermined value;
a trip solenoid for causing the mechanical circuit breaker mechanism to interrupt electrical power flowing through current path in response to a control signal;
voltage and current sensors for measuring voltage and current values of the electrical power flowing through the current path; and
a microprocessor for selectively generating the control signal in response to voltage and current values measured by the voltage and current sensors and a control profile stored in memory for energizing the solenoid and causing the mechanical circuit breaker mechanism to interrupt the electrical power.

2. The circuit breaker system of claim 1, further comprising an optical port for receiving optical signals from an external device for programming the control profile in memory.

3. The circuit breaker system of claim 1, wherein the control profile comprises a maximum allowable current and a maximum allowed time for the current through the current path to exceed the maximum allowable current before the microprocessor generates the control signal.

4. The circuit breaker system of claim 1, wherein the microprocessor is further operable to:
detect an arc fault on the external circuit from measurements made by the voltage and current sensors and a signature stored in memory; and
in response to a detection of an arc fault on the external circuit, generate the control signal for energizing the solenoid and causing the mechanical circuit breaker mechanism to interrupt the electrical power.

5. The circuit breaker system of claim 1, wherein the microprocessor is further operable to:
calculate an energy consumption value for the external electrical circuit from voltage and current measurements from the voltage and current sensors;
store the energy consumption value in memory; and
transmit energy consumption value in memory to an external processing device.

6. The circuit breaker system of claim 5, further comprising an optical port, wherein the microprocessor is operable to transmit the energy consumption value to the external processing device via an optical link established through the optical port.

7. The circuit breaker system of claim 1, further comprising ground fault detection circuitry for detecting a ground fault on the external circuit, wherein the microprocessor is further operable to generate the control signal in response to a ground fault detected by the ground fault detection circuitry for energizing the solenoid and causing the mechanical circuit breaker mechanism to interrupt the electrical power.

8. The circuit breaker system of claim 7, further comprising ground fault self-test circuitry operable to introduce an imbalance between outputs of the ground fault sensors to simulate a ground fault detected on the external circuit.

9. The circuit breaker system of claim 1, further comprising a switch disposed in the current path and operable to open and close to control electrical current flow through the current path in response to a state of another signal generated by the microprocessor.

10. The circuit breaker system of claim 9, wherein the microprocessor is operable to:
in response to a detection of a change in state of the electrical power provided by the electrical power source to the input, generate a first state of the another control signal to open the switch and interrupt current flow through the current path; and
in response to a restoration of the state of the electrical power provided by the electrical power source to the input, generate a second state of the another control signal to close the switch to restore current flow through the current path.

11. The circuit breaker system of claim 10, wherein the microprocessor is operable to:
generate the first state of the another control signal in response disruption of electrical power provided by the electrical power source to the input; and
generate the second state of the another control signal in response to restoration of stable electrical power to the input.

12. The circuit breaker system of claim 10, wherein the microprocessor is operable to generate the first state of the another control signal in response to a reduction of at least one of a voltage and a current provided by the electrical power source to the input of the circuit breaker system.

13. The circuit breaker system of claim 9, wherein the microprocessor is operable to:
in response to command received from one of a plurality of sources, generate a first state of the another control signal to open the switch and interrupt current flow through the current path; and
in response to a command received from each of the plurality of sources, generate a second state of the another control to close the switch and restore current flow through the current path.

14. The circuit breaker 13, wherein the plurality of sources includes a user of the circuit breaker system, a utility controlling the external electrical power source, and detection circuitry within the circuit breaker system.

15. The circuit breaker of claim 1, further comprising a power supply operating from the current path for providing electrical power to the microprocessor.

16. The circuit breaker of claim 15, wherein the power supply comprises a switched-mode power supply.

17. The circuit breaker of claim 15, further comprising power management circuitry for detecting a failure of electrical power generated by the power supply, wherein the microprocessor in response to a failure of electrical power detected by the power management circuitry is operable to save in memory data generated from measurements taken by the voltage and current sensors.

18. The circuit breaker of claim 1, wherein the external electrical circuit comprises a branch circuit within a structure.

19. The circuit breaker of claim 1, wherein the external electrical circuit comprises a circuit within an electrical appliance.

20. The circuit breaker of claim 1, wherein the input includes a power terminal and a neutral terminal for coupling to the power source and the voltage and current sensors measure current with a shunt in the neutral line.

21. A circuit breaker system comprising:
a plurality of circuit breakers, each circuit breaker for controlling current flow from an electrical power source and a corresponding electrical circuit and including an optical port for receiving and transmitting data; and
a control system including an optical port for receiving and transmitting data, the control system operable to establish an optical communications link with at least one of the plurality of circuit breakers.

22. The system of claim 21, wherein the control system comprises a wireless communications port for establishing a wireless communications link with an external device.

23. The system of claim 22, wherein the control system is operable to control the exchange of data between an external device communicating through the wireless communications link and at least one of the plurality of circuit breakers through the optical link.

24. The system of claim 21, wherein the control system is operable to independently configure each of the plurality of circuit breakers through the optical communications link.

25. The system of claim 21, wherein each of the plurality of circuit breakers comprises:
an input for coupling to an external electrical power source, an output for coupling to the corresponding electrical circuit, and a current path selectively coupling the input and the output;
a circuit breaker mechanism for selectively breaking the current path in response to a control signal; and
a microprocessor for selectively generating the control signal in response to a control profile configured by the control system via the optical communications link.

26. The system of claim 25, wherein the circuit breaker mechanism of each of the plurality of circuit breakers comprises:
a mechanical circuit breaker mechanism for breaking the current path; and
a solenoid for causing the circuit breaker mechanism to break the current path in response to the control signal generated by the microprocessor.

27. The system of claim 25, wherein:
each of the plurality of circuit breakers further comprises voltage and current sensors for measuring voltage and current values of the electrical power flowing through the current path; and
the microprocessor of each of the plurality of circuit breakers is operable to generate the control signal in response to voltage and current values measured by the voltage and current sensors and a control profile received via the optical link.

28. The system of claim 25, wherein each of the plurality of circuit breakers comprises a memory and the microprocessor is further operable to store metadata within the memory for characterizing the circuit breaker.

29. The system of claim 28, wherein the control system is operable to store and retrieve metadata in the memory of a selected circuit breaker through the corresponding microprocessor and optical communications link.

30. The system of claim 25, wherein each circuit breaker further comprises a switch operable to open and close to control electrical current flow through the current path in response to a state of another signal generated by the microprocessor.

31. The system of claim 30, wherein the microprocessor of each of the plurality of breakers is operable to:
generate a first state of the another control signal to open the switch in response to detection of a change in a condition of the electrical power provided by the electrical power source to the input and interrupt current flow through the current path; and
after a randomly selected delay time interval, generate a second state of the another control signal to close the switch on restoration of the electrical power provided by the electrical power source to the input and restore current flow through the current path.

32. The system of claim 31, wherein the microprocessor of at least one of the plurality of circuit breakers is operable to generate the first state of the another control signal in response to a change in a condition of the electrical power including a disruption of the electrical power at the input and a reduction of at least one of a voltage and a current at the input.

33. The system of claim 27, wherein each microprocessor is further operable to:
calculate an energy consumption value for the corresponding electrical circuit from voltage and current measurements from the electrical current sensors;
store the energy consumption value in memory; and
transmit energy consumption value in memory to the control system via the optical link.

34. The system of claim 21, wherein the corresponding electrical circuit coupled to at least one of the plurality of circuit breakers comprises a branch circuit within a structure.

35. The system of claim 21, wherein each of the circuit breakers further comprises a switched-mode power supply operating from the current path for supply power to the microprocessor.
